(19) United States
(12) Patent Application Publication
(10) Pub. No.: US 2017/0257363 A1
(43) Pub. Date: Sep. 7, 2017

(54) SECURE MOBILE DEVICE TWO-FACTOR AUTHENTICATION

(71) Applicant: SecureAuth Corporation, Irvine, CA (US)

(72) Inventors: Michael L. Franke, San Clemente, CA (US); Robert Morrison Dana, Reston, VA (US)

(21) Appl. No.: 15/445,067

(22) Filed: Feb. 28, 2017

Related U.S. Application Data
(60) Provisional application No. 62/303,937, filed on Mar. 4, 2016.

(51) Int. Cl. H04L 29/06

(52) U.S. Cl. CPC H04L 63/0853; H04L 63/10; H04L 2463/082

(57) ABSTRACT

A user of a computer seeking to access a protected resource must first authenticate with an authentication appliance. The user provides credentials to the authentication appliance for verification and for use in determining a mobile device associated with the user. The authentication appliance then dynamically generates a reference shared secret, such as an image, pattern, or key, which is also displayed to the user on the computer. The authentication appliance sends an authentication request to an application on the mobile device associated with the user. The application provides an interface in which the user may select, enter, draw, or reproduce the earlier-viewed shared secret on the mobile device. The user-provided secret is then compared to the reference shared secret. If the user-provided secret matches the reference shared secret, then the authentication appliance may provide the user or the computer access to the protected resource.

### CROSS-REFERENCE TO RELATED APPLICATIONS

This application claims the benefit of U.S. Provisional Application No. 62/303,937 entitled “SECURE MOBILE DEVICE TWO-FACTOR AUTHENTICATION,” filed Mar. 4, 2016, the disclosure of which is hereby incorporated by reference herein in its entirety.

### BACKGROUND

Users may seek to use electronic devices such as desktop computers, smartphones, tablets, and notebooks in order to access a secure, protected resource, application, or website over a network. For example, a user may direct a browser on a desktop computer to access a secure website through the internet, in order to receive content or services provided by the secure website. In this example, the desktop computer may be referred to as the client computer, and the secure website may be hosted on one or more computing devices referred to as servers.

The servers do not necessarily trust the client computer or the user using the client computer. Often before substantive communication begins between the client computer and the servers, the servers must authenticate and authorize the client computer. For example, a user may be using their client computer to communicate with a bank's server in order to access their bank account information that is held on the server. In this example, access to a bank account is sensitive and should be restricted only to the owner of the bank account. Thus, the servers may require the client computer and/or the user to authenticate or identify themselves. This authentication process may be performed by an authentication appliance, which may be a computing device, service, or application tasked with controlling access to the desired content. This authentication appliance may sometimes be provided by a third-party authentication service.

One common authentication technique is to request the user to supply authentication factors that are only known (e.g., a username or password) or available (e.g., a physical device or security token) to the user, and which have been previously associated with that user. Most commonly, the authentication process will involve requesting the user to supply a username and/or password via the client computer. However, an unauthorized, malicious user may be able to gain access to the protected resource or circumvent the authentication process, such as if the username and password was written down and stored in an easily discoverable location.

Thus, for extra security, many authentication processes perform multi-factor authentication, which involves not only a password and username, but also additional authentication factors available only to the authorized user and difficult for others to obtain. Mobile phone two-factor authentication (2FA) is a type of multi-factor authentication that uses mobile devices, such as mobile phones and smartphones, to serve as “something that the user possesses” and assumes that the mobile device is a trusted device in the possession of the authorized user. Although current implementations of mobile phone two-factor authentication may provide improved usability and convenience to users by eliminating the need for an additional, dedicated security token, users still remain susceptible to phishing attacks and fraudulent authentication requests.

### SUMMARY

Embodiments of the systems, methods, and devices described herein overcome problems of the prior art and, among other things, improve the security of mobile phone two-factor authentication systems against phishing attacks and fraudulent authentication requests.

In some embodiments, a computing appliance is disclosed for performing multi-factor authentication, the appliance comprising: one or more processors; a computer-readable memory; and an authentication program comprising executable instructions stored in the computer-readable memory. The executable instructions direct the one or more processors to at least: obtain a set of user credentials from a client computer, wherein the set of user credentials are associated with a user identity; access a database containing a set of reference user credentials; verify the user identity by comparing the set of user credentials with the set of reference user credentials; determine a mobile device associated with the user identity; generate a shared secret; transmit the shared secret to the client computer to be displayed on the client computer; transmit an authentication request to the mobile device, wherein the authentication request is configured to be accessed by an application on the mobile device in order to obtain a user-supplied secret; obtain an authentication response from the mobile device; upon obtaining the authentication response, verify the user-supplied secret matches the shared secret; and upon verifying that the user-supplied secret matches the shared secret, provide the client computer access to a protected resource.

In some configurations, the shared secret comprises a pattern. In some configurations, the shared secret comprises an image. In some configurations, the authentication request comprises a push notification. In some configurations, the authentication response comprises the user-supplied secret, and in order to verify that the user-supplied secret matches the shared secret, the executable instructions further direct the one or more processors to compare the user-supplied secret from the authentication response with the shared secret. In some configurations, the authentication response comprises an indication that the user-supplied secret matches the shared secret, and in order to verify that the user-supplied secret matches the shared secret, the executable instructions further direct the one or more processors to assess the indication in the authentication response. In some configurations, the mobile device comprises a smart phone or a mobile phone. In some configurations, the authentication request comprises information associated with the shared secret.

In some embodiments, a computerized method is disclosed for performing multi-factor authentication, the method comprising: by one or more hardware processors executing computing instructions: receiving a set of user credentials from a client computer, wherein the set of user credentials are associated with a user identity; accessing a database containing a set of reference user credentials; verifying the user identity by comparing the set of user credentials with the set of reference user credentials; determining a mobile device associated with the user identity; generating a shared secret; transmitting the shared secret to the client computer to be displayed on the client computer; transmitting an authentication request to the mobile device, wherein the authentication request is configured to be accessed by an application on the mobile device in order to obtain a user-supplied secret; receiving an authentication response from the mobile device; upon receiving the authentication response, verifying the user-supplied secret matches the shared secret; and upon verifying that the user-supplied secret matches the shared secret, providing the client computer access to a protected resource.

In some configurations, the shared secret comprises a pattern. In some configurations, the shared secret comprises an image. In some configurations, the authentication response comprises the user-supplied secret, and the method further comprises comparing the user-supplied secret from the authentication response with the shared secret. In some configurations, the authentication response comprises an indication that the user-supplied secret matches the shared secret, and the method further comprises assessing the indication in the authentication response. In some configurations, the mobile device comprises a smart phone or a mobile phone. In some configurations, the authentication request comprises information associated with the shared secret.

In some embodiments, a non-transitory computer storage medium is disclosed which stores a mobile client application comprising executable code that directs a mobile device to perform a process comprising: accessing an authentication request transmitted from an authentication appliance. The authentication appliance is configured to: obtain a set of user credentials from a client computer, wherein the set of user credentials are associated with a user identity; access a database containing a set of reference user credentials; verify the user identity by comparing the set of user credentials with the set of reference user credentials; determine the mobile device, wherein the mobile device is associated with the user identity; generate a shared secret; transmit the shared secret to the client computer to be displayed on the client computer; transmit the authentication request to the mobile device, wherein the authentication request is configured to be accessed by the application in order to obtain a user-supplied secret; obtain an authentication response from the mobile device; upon obtaining the authentication response, verify the user-supplied secret matches the shared secret; and upon verifying that the user-supplied secret matches the shared secret, provide the client computer access to a protected resource. The process that the mobile device is directed to perform further comprises: generating an interactive authentication interface configured to allow a user of the mobile device to provide the user-supplied secret, wherein the user is associated with the user identity; obtaining, through the interactive authentication interface, the user-supplied secret from the user; and upon obtaining the user-supplied secret, sending the authentication response to the authentication appliance.

In some configurations, the interactive authentication interface comprises a pattern lock and the user-supplied secret comprises a pattern lock pattern. In some configurations, the interactive authentication interface comprises a plurality of images and the user-supplied secret comprises an image selected from the plurality of images. In some configurations, the authentication response comprises the user-supplied secret. In some configurations, the mobile client application comprising executable code directs the mobile device to, prior to sending the authentication response to the authentication appliance, verify that the user-supplied secret matches the shared secret, with the authentication response comprising an indication that the user-supplied secret matches the shared secret.

Note, although the system may comprise a prebuilt appliance or server with hardware processors, the system may also, in some embodiments, comprise a virtual appliance (such as a VMWare image that can be used to emulate an appliance on any standard computing system that supports virtual images). For more information and background on other configurations, features, functions, and options of the appliance and/or client devices, see U.S. Pat. Nos. 8,327,142, 8,301,877, 8,707,031, 8,613,067, 8,510,816, 8,769,651, and U.S. Provisional Patent Application 61/941286, filed Feb. 18, 2014, each of which are incorporated herein by reference in their entirety for all purposes.

### BRIEF DESCRIPTION OF THE DRAWINGS

The following drawings and the associated descriptions are provided to illustrate embodiments of the present disclosure and do not limit the scope of the claims. Aspects and many of the attendant advantages of this disclosure will become more readily appreciated as the same become better understood by reference to the following detailed description, when taken in conjunction with the accompanying drawings, wherein:

FIG. 1 is a system diagram illustrating an example environment in which one embodiment of the mobile device authentication system may be implemented, including various connected devices and networks.

FIG. 2 is a flowchart illustrating how an authentication appliance may control access to a protected resource for a user identity, according to one embodiment of the present disclosure.

FIG. 3 is an activity diagram illustrating some of the interactions between the components of one embodiment of the mobile device authentication system during the authentication process.

FIG. 4 is an activity diagram illustrating some of the interactions between the components of one embodiment of the mobile device authentication system during the registration process.

FIG. 5 is an example user interface for viewing a pattern on a computing device, according to one embodiment of the present disclosure.

FIG. 6 is an example user interface for requesting a pattern be drawn on a mobile device, according to one embodiment of the present disclosure.

FIG. 7 illustrates the example user interface in FIG. 6 after a pattern has been drawn.

FIG. 8 is a block diagram that illustrates various example contents of a pattern-based authentication request sent to a mobile device, according to some embodiments of the present disclosure.

FIG. 9 is a block diagram that illustrates various example contents of a pattern-based authentication response sent from a mobile device, according to some embodiments of the present disclosure.

FIG. 10 is an example user interface for viewing an image on a computing device, according to one embodiment of the present disclosure.

FIG. 11 is an example user interface for requesting an image be selected on a mobile device, according to one embodiment of the present disclosure.

FIG. 12 is a block diagram that illustrates various example contents of an image-based authentication request sent to a mobile device, according to some embodiments of the present disclosure.

FIG. 13 is a block diagram that illustrates various example contents of an image-based authentication response sent from a mobile device, according to some embodiments of the present disclosure.

FIG. 14 is a block diagram that illustrates a computer system upon which an embodiment of the mobile device authentication system may be implemented.

### DETAILED DESCRIPTION OF PREFERRED EMBODIMENTS

Although certain preferred embodiments and examples are disclosed below, the inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

### Introduction

The present disclosure is directed to systems and methods of mobile phone and tablet two-factor authentication schemes for providing a computing device access to a protected resource. Specifically, the disclosure relates to authentication schemes in which a shared secret, such as an image or pattern, is shown via a computing device. In order to complete the authentication scheme, the user must enter, select, or match the shared secret in an application on their mobile device. These systems and methods reduce the incidences of users providing additional authentication factors on their mobile device in response to a fraudulent authentication request. The disclosure also allows native mobile applications on the mobile device to leverage web or non-web technology to perform authentication and authorization for a single user identity.

In order to facilitate an understanding of the disclosed embodiments, an overview will initially be provided of existing authentication processes.

A user of a computer, such as a computer terminal, mobile device, or any other similar electronic device capable of receiving digital content, may seek to obtain access to a protected resource, such as a secure website. In some scenarios, the computer may be a PC or Mac.

In order to be granted access to the protected resource, the user may first have to authenticate. For example, if the protected resource was a company's VPN, the VPN may be protected by some form of authentication software, which requests the user to authenticate on the client computer. In some configurations, the authentication may be performed by a third-party service. Other example authentication mechanisms, authentication information, and workflows are depicted in US application publications with application Ser. Nos. 11/702,371, 12/075,219, 12/326,002, 12/392,760, 12/419,951, 12/948,037, 13/035,289, and 13/830,506, the disclosures of which are hereby incorporated by reference.

The user may then attempt to log on using their computer by entering credentials associated with their user identity, such as their User ID and Password. After the user enters this information, the authentication software may verify the user's identity and inform the user that they need to take further action to allow the logon transaction to continue.

At this point, the authentication software may also initiate the mobile device portion of the authentication sequence. The authentication software may send a push notification to the user's mobile device, which may be a mobile phone, smartphone, tablet, and so forth. This mobile device may be associated with the user's identity during the registration process. The user may then open this received push notification, which may open an application on the mobile device. In some configurations, the application may be a web browser that is re-directed to a URL for web-based authentication. The application may then direct the user to perform some kind of action to complete the authentication sequence. This could range from providing a simple confirmation that the mobile device is in the user's possession to more complex actions. It may be desirable to strike a delicate balance for this mobile device portion of the authentication sequence, such that it is simple enough to be convenient for the user to routinely perform but complex enough to be secure against phishing attacks and fraudulent authentication requests.

For example, one phishing scenario may involve a malicious user obtaining the username and password for a user identity. The malicious user may attempt to access the protected resource using the stolen credentials to initiate the authentication process. The authentication software may then initiate the mobile device portion of the authentication sequence by requesting the user associated with the user identity perform an additional action on their mobile device. The malicious user may be hoping that the actual user performs this action on their mobile device without serious scrutiny and without realizing that they did not initiate the authentication process. In this manner, it is possible for the malicious user to obtain access to the protected resource even if the mobile device remains strictly in the possession of the authorized user.

Even if an individual user realizes the authentication request is fraudulent, it may not be enough to stop a malicious user, for whom it is a numbers game. The malicious user may have stolen credentials for multiple user identities and may only need one of those users to complete the authentication sequence in order to compromise the protected resource. Since it may be easier to predict the behavior of a group as opposed to the behavior of an individual, it may be desirable to assess the effectiveness of the mobile device portion of the authentication sequence in regards to a group of users rather than to an individual user. Thus, an authentication scheme can be designed to be more secure against phishing for users in general, as well as designed to be more convenient for users in general.

By way of example, some configurations for the mobile device portion of the authentication sequence may involve an application on the mobile device presenting the user with two options—“Accept” or “Deny”. In order to complete authentication, the user may press “Accept” in order to grant a computer access to the protected resource. However, this results in the user having to press “Accept” each time access to the protected resource is desired. After having pressed “Accept” many times, the user may become conditioned to press “Accept” when it appears on their phone out of habit. Many users, when prompted with the option to “Accept” or “Deny”, may routinely press “Accept” even if they did not initiate the authentication sequence themselves (e.g., they are not trying to logon to the protected resource on their computer). This defeats the purpose of having an additional authentication factor because stolen user identities, which can be obtained through a phishing attack, can still be utilized to access the secure resource. Users that routinely press “Accept” for authentication sequences initiated by malicious users will end up granting the malicious users access without ever becoming aware that their user identity has been stolen.

In some configurations, the mobile device portion of the authentication sequence may involve an application on the mobile device requesting the user provide some kind of information that the user may know outside of the authentication sequence. For example, a user may be required to enter a known passcode into the mobile device. However, this may result in the user having to enter the same passcode each time access to the protected resource is desired. If the user chose their passcode, they may choose passcodes that they also use for other routine aspects of their lives (e.g., bank PINs, account passwords, birthdates). Over time and repetition, this process may become habitual and susceptible to the same phishing vulnerabilities as requesting that the user press the “Accept” button. The user may end up entering their passcode into their mobile device even when they did not initiate the authentication sequence.

In some other configurations, the mobile device portion of the authentication sequence may involve sending information through an out-of-band communication channel to the mobile device. For example, a one-time-valid code may be sent to the mobile device by SMS or voice message over a telephone network. The user may have to enter this one-time-valid code in the application on their mobile device, or the user may have to enter the one-time-valid code into the user interface of the computer that is seeking access to the protected resource. However, information sent to the mobile device, through channels such as SMS, may be insecure and capable of being intercepted. Although this authentication scheme may reduce the chances of users acting on auto-pilot to complete the authentication process, it may open up users to further vulnerabilities or unnecessarily inconvenience users.

Alternatively, in some configurations, if verification of the user's is successful, the authentication software may dynamically generate a shared secret. The user interface on the user's computer, and only the user's computer, may visually present the shared secret. The shared secret may be any kind of data that is known only to the authentication software and the user via the user's computer. In some configurations, the shared secret may be a pattern and the user may be expected to reproduce the pattern on their mobile device. In other configurations, the shared secret may be an image and the user may be expected to select that specific image among a plurality of images shown on their mobile device. In yet other configurations, the shared secret may be a key that the user may be expected to select or enter on their mobile device. In yet other configurations, the shared secret may be either a challenge or a response for a challenge-response sequence, and the user may be expected to provide the complimentary response or challenge to the shared secret on their mobile device.

The authentication software may then send a push notification to the user's mobile device, which may be a mobile phone, smartphone, tablet, and so forth. The user may then open this received push notification, which may open (e.g., automatically) an application on the mobile device. In some configurations, the application may be a web browser that is re-directed to a URL for web-based authentication. The user may then provide replicate, select, or enter the shared secret into the application on their mobile device. If the shared secret the user entered is correct, then the authentication software may grant the user access to the protected resource on their computer.

Presenting a dynamically-generated shared secret strictly on the user's computer for the user to replicate, enter, or select on their mobile device in this manner may provide many advantages. If the user is presented with the shared secret only through their computer, it reduces the likelihood that the user will be able to complete an authentication sequence that they did not initiate themselves. If a malicious user attempted to use a user's stolen identity to access a protected resource, only the malicious user would be presented with the shared secret on their computer. The authorized user would not be aware of the shared secret since the user did not initiate the authentication sequence. Thus, the authorized user would be unable to enter the shared secret into their mobile device to grant the malicious user access to the protected resource, except in the extremely rare occasion that the user may guess the correct shared secret by chance.

The chances of a correct guess occurring may depend on the format of the shared secret and is further reduced by dynamically generating the shared secret so that it is different for every authentication sequence. Furthermore, utilizing a changing shared secret rather than requiring a habitual confirmation, like pressing “Accept”, may prevent users from operating on auto-pilot and encourage them to be more aware of their actions. Requiring users to know the appropriate shared secret beforehand (e.g., knowing what to select or draw) makes users more cognizant of authentication requests not initiated by them. The users are much less likely to be randomly guessing the shared secret in the first place when they receive a fraudulent request or unsolicited push notification. Thus, completed authentication sequences are more likely to be a result of the user's identity being properly validated and uncompromised by security threats.

### Description of the Figures

Although aspects of the embodiments described in the disclosure will focus, for the purpose of illustration, on relationships and interactions between mobile devices, mobile applications, authentication servers, and network services, one skilled in the art will appreciate that the techniques disclosed herein may be applied to any number of hardware or software processes or applications. For example, although the disclosure focuses primarily on the context of smartphones, the disclosed processes can also be used with other types of mobile devices, such as tablets and e-readers. Further, although various aspects of the disclosure will be described with regard to illustrative examples and embodiments, one skilled in the art will appreciate that the disclosed embodiments and examples should not be construed as limiting. The embodiments may include several novel features, no single one of which is solely responsible for its desirable attributes or which is essential to practicing the embodiments of the disclosure herein described.

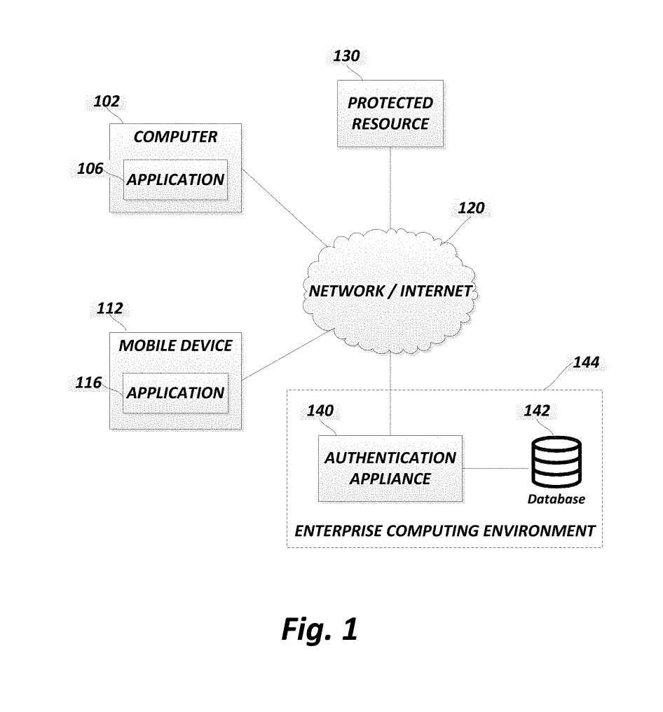

### I. Example Implementation Environment (FIG. 1)

FIG. 1 is a system diagram illustrating an example environment in which one embodiment of the mobile device authentication system may be implemented, including various connected devices and networks.

A Network 120 may be used to link Computer 102, Mobile Device 112, Protected Resource 130, and Enterprise Computing Environment 144. The Network 120 may include any collection of wired or wireless signals used by the devices and components of the system to communication with each other. For example, Network 120 may include a telecommunications network, such as those based on mobile telecommunications technology like 3G, 4G, and so forth, which are frequently used by mobile devices. Network 120 may also include the Internet, or any other type of network such as a Local Area Network (LAN), a Wide Area Network (WAN), a Wireless Local Area Network (WLAN), a Metropolitan Area Network (MAN), a Storage Area Network (SAN), a Personal Area Network (PAM), an Enterprise Private Network (EPN), or a Virtual Private Network (VPN).

It should be noted that Network 120 as seen in the figure may be an abstraction, as Network 120 may actually be multiple individual networks. As an example, Computer 102 may be connected to Protected Resource 130 and Enterprise Computing Environment 144 via connections provided by an Internet Service Provider. However, Enterprise Computing Environment 144, or Authentication Appliance 140, may communicate with Mobile Device 112 using a telecommunications network, such as those based on telecommunications technology.

Enterprise Computing Environment 144 may be a collection of enterprise servers that provide enterprise services. Enterprise Computing Environment 144 may provide network-based authentication services. In some configurations, Enterprise Computing Environment 144 may comprise any business-oriented system, device, application, service, or information technology configured to benefit a company's operations. For example, Enterprise Computing Environment 144 may include one or more enterprise services, network services, authentication servers or appliances such as Authentication Appliance 140, and/or databases such as Database 142. In the illustrated embodiment, Enterprise Computing Environment 144 comprises Authentication Appliance 140 and Database 142.

Protected Resource 130 may be anything able to convey information or content in a digital format, such as a flash drive or computer-readable storage medium, a digital file, a cloud computing cluster, a network or virtual private network (VPN), a web page or web resource, and so forth. Protected Resource 130 may also be a collection of servers that provide services. Examples of some provided services include calendaring, email, document management, file services, or any other application that uses client/server architecture. In some configurations, Protected Resource 130 may be a website that is accessible over the Internet. In some configurations (not shown), Protected Resource 130 is hosted within Enterprise Computing Environment 144.Protected Resource 130 may be secured with its own authentication software or by the authentication service of a third-party. In some configurations, Protected Resource 130 may be secured by Authentication Appliance 140 running within Enterprise Computing Environment 144. For example, if Company.com used Enterprise Computing Environment 144 to provide network-based authentication services for its employees via Authentication Appliance 140, the employee “John Smith” at Company.com may have to authenticate with Authentication Appliance 140 in order to access a protected resource of Company.com, such as a VPN.

In some configurations, the Protected Resource 130 may have an authentication module that can be implemented with hardware or software, or an equivalent combination of the two. The authentication module of Protected Resource 130 may store a Uniform Resource Locator (URL) that it can use to direct Application 106 to access an authentication website or Authentication Appliance 140, such as when Application 106 is attempting to access Protected Resource 130 without having authenticated. In some configurations, the authentication module of Protected Resource 130 may be configured to allow Application 106 access once it has determined that the user behind Computer 102 has been authenticated.

In other configurations, Application 106 may have the authentication module. In some embodiments, the stored URL may be configurable by an administrator prior to or after the download or install of Application 106. In addition, Application 106 may be capable of storing multiple authentication URLs, where a different URL can be used depending on the Protected Resource 130 to be accessed, or a characteristic of the user looking to access Protected Resource 130 (e.g., enterprise, domain or network, username or user identity, or other attribute).

Authentication Appliance 140 may be a server or multiple servers that resides either on a corporate or organizational enterprise's network in an Enterprise Computing Environment 144, or as a cloud service external to the enterprise (not shown). It is also sometimes known as an authentication, logon, authorization or security service. In some configurations, Authentication Appliance 140 may be a software application or a service.

In some embodiments, Authentication Appliance 140 may be operated by a specific enterprise to authenticate its users. For example, Adobe's IT department might run an authentication server for all of Adobe's employees to verify employees' authentication credentials, such as usernames, passwords, or other identifying information described herein. Alternatively, Authentication Appliance 140 may be operated by a third party to authenticate an enterprise's users, or user's subscribing to the enterprise's or the third party's services. Authentication Appliance 140 may provide authentication services for a variety of resources that require authentication, such as restricted local features/applications on a computer or mobile device, or network-based application services such as web services, email, calendaring, etc.

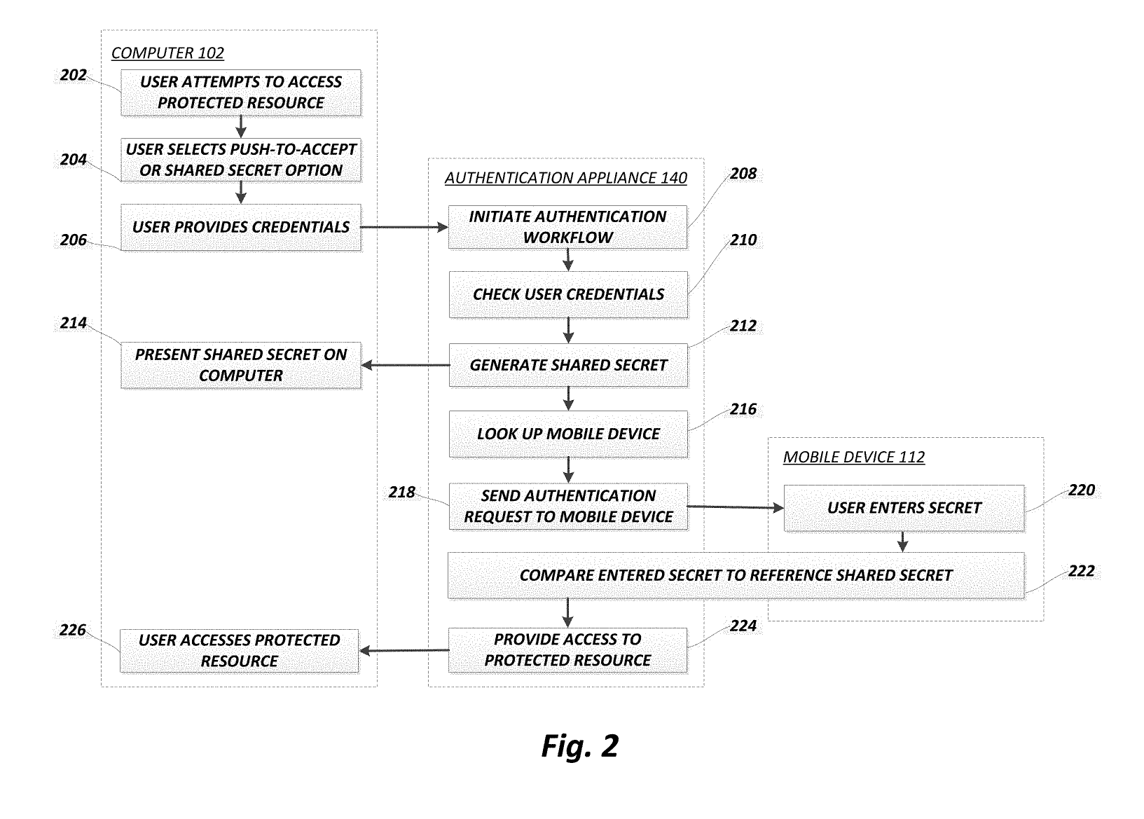

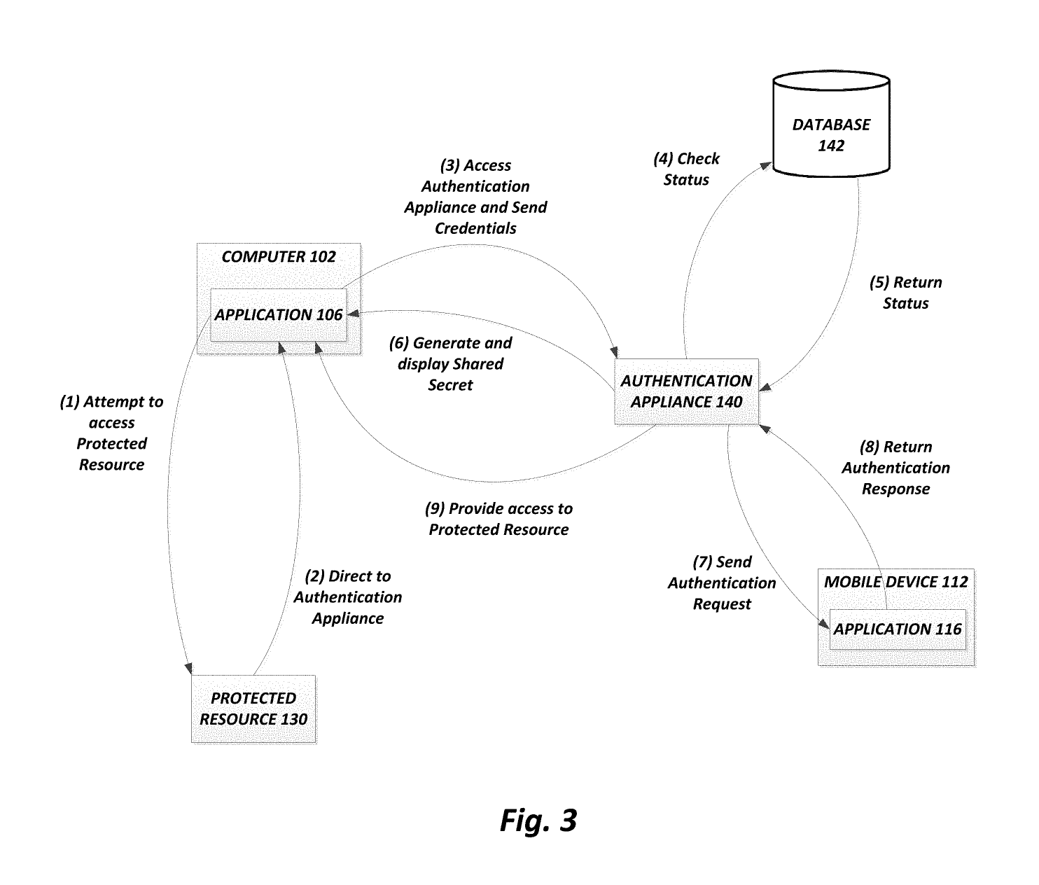

Authentication Appliance 140 may allow users and/or devices to authenticate prior to gaining access to network services, such as those provided by Protected Resource 130. Authentication Appliance 140 may initiate an authentication process or workflow, and it may do so in response to an attempted access of Protected Resource 130. Authentication Appliance may be configured to communicate with Computer 102, Mobile Device 112, and/or Protected Resource 130 in order to carry out the authentication process. Examples of this authentication process or workflow are provided in further detail in regards to FIG. 2 and FIG. 3. In some configurations, Authentication Appliance 140 may access an identity database, such as Database 142, to verify credentials received from a device, and/or lookup any authentication or authorization information associated with a user or device. In some configurations, verifying a user's credentials may involve comparing the user-supplied credentials against the reference credentials stored within Database 142 in order to identify a match.

Database 142 may be any collection of information that is organized to be accessible, manageable, and updateable and, in some configurations, could represent multiple databases or collections of information. Database 142 may be any collection of data associated with user identities or credentials. Database 142 may include, by way of example, SQL databases, Microsoft Active Directory servers, LDAP directories, Kerberos servers, certificate servers, RADIUS servers, or any other database, on premises or in the cloud (e.g., hosted off-site by, in some cases, a third party), that stores or authenticates user credentials and/or profiles. In some configurations, Database 142 may store the usernames and passwords of various user identities that are permitted to access Protected Resource 130. In some of such configurations, Database 142 may also store phone numbers or mobile device identifiers associated with the user identities, which can be used to send information or signals to the mobile device associated the user. In other configurations, a separate database (not shown) may store the phone numbers or mobile device identifiers. In some configurations, Database 142 may store authorization information on users associated with Protected Resource 130 and can be used to determine whether a user is authorized to use a specific feature or service within Protected Resource 130. In this scenario, Computer 102 may only have access to certain aspects or features of Protected Resource 130 if the authentication process is successful.

Computer 102 may be any computing device capable of accessing Protected Resource 130. Computer 102 may be any computing device used to initiate the authentication process. Computer 102 may be a personal computer or workstation that functions as a client device. Computer 102 may have a central processing unit, storage devices, and the like. Computer 102 may also include display units and/or input devices, such as a keyboard or mouse. Computer 102 may also be a mobile device or other portable electronic device, such as a smartphone, tablet or notebook computer, since the distinction between mobile devices and traditional computers is becoming increasingly blurred as they share many of the same capabilities.

Computer 102 may have Application 106, which may be used to access the Protected Resource 130 over the Network 120. Application 106 may be an application that is downloaded or installed on Computer 102 before it is launched. In some configurations, Application 106 is a standalone application. In some configurations, Application 106 may be a browser, such as a web browser configured to browse webpages on the Internet. In other configurations, Application 106 may be configured to work with other applications in accessing Protected Resource 130. In some of such configurations, Application 106 may be configured to work with a browser. For example, if the browser is directed to the URL of Protected Resource 130, Application 106 may step in to initiate the authentication process before Protected Resource 130 can be viewed on the browser. In some configurations, Application 106 is configured to access Protected Resource 130 upon opening. For example, if Application 106 is Outlook, then it may attempt to access emails that are stored in a secure server when opened.

Mobile Device 112 may be any computing device that is separate and distinct from Computer 102. Mobile Device 112 may be a personal computer or workstation, or it may be a mobile phone or other portable electronic device, such as a tablet or notebook computer. Mobile Device 112 may have a central processing unit, storage devices, and the like. Mobile Device 112 may also include display units and/or input devices, such as a touchscreen, keyboard, and so forth. In some embodiments, Mobile Device 112 is a smart phone with a touch screen that makes it simple and convenient for a user to quickly provide input (e.g., the selection of user interface elements shown on the screen) without the use of additional input peripherals, such as a keyboard, mouse, stylus, and so forth.

Mobile Device 112 may be connected to the global internet via wireless networking. Typical network connectivity involves either an 802.11 Wi-fi connection, or other 3G or 4G cellular data technology, such as GSM, EDGE, UMTS, WCDMA, EV-DO, LTE, etc. Such connectivity allows the mobile device, browser, and client apps to communicate to resources on TCP/IP networks, or other OSI layer 3 networks, such as Network 120 or the Internet. Resources that can be contacted include, by way of example, Authentication Appliance 140 and Enterprise Computing Environment 144.

Mobile Device 112 may have Application 116 for performing authentication. In some embodiments, Application 116 is an application on a smartphone operating system, such as Apple's iOS and Google's Android and the Windows RT. Application 116 may operate in a complex computer and networking environment, and it may be written to execute on a mobile device, typically a smart phone. Application 116 may be native software, in that it can only function within their native architecture or operating system. For example, an application designed for Apple's iOS operating system and written in Objective C will not function on Google Android phones. Application 116 may be downloaded or installed on a mobile device using cloud distribution channels. For example, Apple's iPhone product has the ability to download iOS client apps from the iTunes service, and Android phones can download Android client apps from Google Play. In some configurations, Application 116 may have integrated browser capabilities for performing web-based authentication. In other configurations, Application 116 may be configured to interact with a separate browser for performing web-based authentication.

Application 116 may be configured to receive information and signals from Authentication Appliance 140. Application 116 may be configured to carry out the mobile device portion of the authentication sequence. Application 116 may allow the user to provide additional authentication factors in order to complete the authentication process and grant Computer 102 access to Protected Resource 130. Application 116 may provide an user interface for the user to provide the correct additional authentication factors.

In some configurations, Application 116 may comprise a browser, such as a web browser capable of accessing websites on the Internet. The browser may be a native web browser, such as the web browsers preinstalled on mobile devices likes the iPhone or a similar Android device. The browser may allow mobile users to access various Uniform Resource Locators (URLs). The browser may have most of the capabilities of normal web browsers, such as sending and receiving HTTP and HTTPS communications, running client side managed code such as Java and Javascript, and rendering various received data. Mobile browsers can store received information in a variety of data stores, including standard HTML4 browser cookie space, HTML5 storage space, including HTML5 Local Storage, HTML Session Storage, HTML5 Global Storage, HTML SQLLight Storage, Adobe Flash Space, Android Dalvik Storage space, J2MEManaged code space, Microsoft.NET code space, and Native X.509v3 Certificate storage space and SDROM file space. Upon receiving a signal from Authentication Appliance 140, the browser may be re-directed to a URL for web-based authentication. The browser may provide the user interface for the user to provide the correct additional authentication factors needed to complete the authentication process.

In some configurations, Application 116 may be configured to work in conjunction with a separate browser. Upon receiving a signal from Authentication Appliance 140, Application 116 may re-direct the separate browser to a URL for web-based authentication. The separate browser may provide the user interface for the user to provide the correct additional authentication factors.

### II. Example Interactions (FIGS. 2-4)

FIG. 2 is a flowchart illustrating how an authentication appliance may control access to a protected resource for a user identity, according to one embodiment of the present disclosure.

FIG. 3 is an activity diagram illustrating some of the interactions between the components of one embodiment of the mobile device authentication system during the authentication process.

Since Authentication Appliance 140 is an integral feature of the authentication process common to both FIG. 2 and FIG. 3, it may be helpful to interpret FIG. 2 and FIG. 3 together rather than separately.

With respect to FIG. 2, at Block 202, a user may attempt to access a Protected Resource 130 on Computer 102. In some embodiments, the user may be attempting to access Protected Resource 130 over Network 120 through Application 106 on Computer 102. In some configurations, Application 106 may even be a browser, and attempting to access Protected Resource 130 may involve directing the browser to the URL of Protected Resource 130. In other configurations, Application 106 is not a browser. For example, the user may be attempting to access their company's VPN through a VPN client on Computer 102. In either case however, in order to access Protected Resource 130, the user first has to be authenticated to prevent unauthorized access to Protected Resource 130.

In some embodiments, Protected Resource 130 will recognize that the user has not yet been authenticated and will deny access to the user until they are authenticated. In some of such embodiments, Protected Resource 130 may be configured to direct the user to Authentication Appliance 140 through Application 106 (or a separate browser). In some embodiments, Application 106 may recognize that the user has not yet been authenticated and direct the user (either through Application 106 or a separate browser) to Authentication Appliance 140 without the aid of Protected Resource 130. In some embodiments, Authentication Appliance 140 is web-based and Application 106 (or a separate browser) is directed to the URL of the authentication website associated with Authentication Appliance 140. The URL of Authentication Appliance 140 can be retained by either the Protected Resource 130 or Application 106.

In some embodiments, a logon user interface is provided on Computer 102 that allows the user to provide Authentication Appliance 140 with credentials associated with their user identity. For extra security, Authentication Appliance 140 may request additional authentication factors designed to be only available to the authorized user and difficult for any unauthorized users to obtain. In some embodiments, Authentication Appliance 140 may negotiate the method of authentication. In some of such embodiments, this logon user interface may provide the user with various selectable options for performing multi-factor authentication. In some of such embodiments, this logon user interface may provide an option for performing some form of mobile device two-factor authentication. In other embodiments, the user may be forced to perform some kind of mobile device two-factor authentication, such as the authentication scheme described herein, rather than provided a choice.

In some embodiments, the logon user interface is generated by an authentication module of Protected Resource 130, which may collect the user-submitted credentials and selected authentication method to submit directly to the Authentication Appliance 140. In some embodiments, the logon user interface is generated within Application 106, which may collect the user-entered credentials and selected authentication method to submit to Authentication Appliance 140. In some embodiments, Authentication Appliance 140 may be configured to have an associated logon user interface that is generated after communications between Computer 102 and Authentication Appliance 140 is established. For example, if Authentication Appliance 140 is web-based, then the logon user interface may be generated in a separate browser on Computer 102 that collects the user-submitted credentials and selected authentication method to submit to Authentication Appliance 140.

With respect to FIG. 2, at Block 204, the user may select in the logon user interface to utilize either a “shared secret” or a “push-to-accept” second factor option for an authentication scheme. It should be noted that both terms may be associated with the mobile device two-factor authentication methods discussed herein and may, at times, be used interchangeably. The term “push-to-accept” encompasses authentication schemes that go beyond a user pushing a single button on their mobile device in order to advance the authentication process.

At Block 206, the user may provide credentials associated with a user identity to Authentication Appliance 140. Typically, credentials may include a username or user ID and a password.

At Block 208, Authentication Appliance 140 receives the user-submitted credentials and initiates the authentication workflow. In some configurations, Authentication Appliance 140 may at this point determine or confirm whether a “shared secret” or “push-to-accept” scheme is available as a way of obtaining an additional authentication factor. Availability may depend on the configuration of Protected Resource 130 or the attributes of the user and/or Computer 102 (e.g., if the user is using a limited-duration guest account or guest computer, it may be known that there would be no mobile device associated with the user).

At Block 210, Authentication Appliance 140 may check and verify the user credentials. Authentication Appliance 140 may verify the user credentials by comparing the user-supplied credentials with a set of reference credentials. In some configurations, the set of reference credentials may be stored in Database 142 as shown in FIG. 1. If the user-supplied credentials are verified, then the authentication process may proceed. However, if the user-supplied credentials are unable to be verified, the authentication process may stop or restart, with the user having to provide credentials all over again. In some embodiments, Authentication Appliance 140 may verify the credentials by accessing an identity database, such as Microsoft's Active Directory, in order to determine whether there is a stored reference user identity associated with the credentials.

In some configurations, Authentication Appliance 140 may at this point determine or confirm whether a “shared secret” or “push-to-accept” scheme is available as a way of obtaining an additional authentication factor. For example, if the reference user identities are in the same database as the phone numbers or mobile device identifiers associated with those user identities, then Authentication Appliance 140 could efficiently determine at the same time whether a Mobile Device 112 is associated with the user identity and available to be used in providing the additional authentication factor. In some configurations, Database 142 may also contain the number or mobile device identifier for the Mobile Device 112 that is associated with the credentials for that user or device. Thus, Authentication Appliance 140 may look up the phone number or mobile device identifier while verifying the user's credentials.

At Block 212, Authentication Appliance 140 has successfully verified the user identity and generates a shared secret. The shared secret is dynamically generated for each authentication sequence. As described previously, the shared secret may be any kind of data that can be generated and known by Authentication Appliance 140 while presented to the user via Computer 102, which was used to initiate the authentication process. In some configurations, the shared secret is visually presented to the user on a user interface on the user's computer. The format of the shared secret varies across different embodiments.

In some embodiments, the shared secret may be a pattern and the user may be expected to reproduce the pattern on their mobile device. For example, the pattern may be a swipe pattern for a pattern box or a pattern lock, which is typically used with mobile devices having touchscreens. The user may be informed that they will need to take further action to complete the authentication process by drawing that pattern in an application on their mobile device. The application on their mobile device may have a user interface in which the user may reproduce the pattern. For example, the application may display a pattern box in which the user may need to draw out the shared secret pattern in order to complete the authentication sequence.

In some embodiments, the shared secret may be an image, picture, or symbol and the user may be expected to select that specific image out of a bank of images presented on their mobile device. For example, the image may be an image of letter or number. The user may be informed that they will need to take further action to complete the authentication process by selecting that image in an application on their mobile device. The application on their mobile device may have a user interface displaying a number of selectable images for the user to choose from. For example, the application may display nine letters and the user may need to select the letter that matches the shared secret in order to complete the authentication sequence.

In some embodiments, the shared secret may be a key that the user selects or enters on their mobile device. For example, the shared secret may be a number, word, sequence, or so forth that must be entered into the mobile device. In yet other configurations, the shared secret may be either a challenge or a response for a challenge-response sequence, and the user may be expected to provide the complimentary response or challenge to the shared secret on their mobile device. For example, the shared secret may request the user choose a vowel and the user may have to select from a plurality of letters, only one of which is a vowel.

From a statistical perspective, requiring a user to enter, select, draw, reproduce, or match the shared secret in their mobile device may not completely remove the chance of a user providing the additional authentication factor for a fraudulent request. For example, if the user must select a single matching image when presented with a total of nine images on their mobile phone, there is still the chance that the user may select an image at random despite them not having initiated the authentication process. In this scenario, there would be a one-in-nine chance that the user actually selects the matching image and provides the additional authentication factor needed for the fraudulent request.

However, from a human perspective, requesting the user to enter, select, draw, reproduce, or match the shared secret in their mobile device is very effective because the user has not been conditioned to just press a single button (e.g., “Accept”) without thinking. Instead, by requiring the user to know the corresponding shared secret beforehand (e.g., knowing what to pick or draw), the user is much less likely to be randomly guessing in the first place when they receive a fraudulent request or unsolicited push notification.

Should the chance of a user randomly guessing correctly be a significant concern, that chance can be changed by altering the format and parameters of the shared secret. This may affect how secure the authentication process is, as well as how convenient it is for users. In the example where the user must select a single matching image out of a total of nine images, the chance of a user randomly guessing correctly can be reduced by increasing the number of images that the user must select from, at the cost of reduced convenience for the user. The chance can be reduced even further by requiring the user select multiple images, numbers, or letters, and even further yet by requiring the multiple images be selected in a specific sequence (e.g., forming a word). For the example where the user must draw a pattern in a pattern box, the chance of a user randomly guessing correctly can be reduced by increasing the size of the pattern box or increasing the number of strokes in the pattern.

Thus, the format and parameters of the shared secret may be selected based on the desired goals of the authentication process, and to strike a specific balance between security and convenience. In some configurations, Authentication Appliance 140 may be able to determine the format of the shared secret based on an internal configuration, the security settings of the Protected Resource 130, the risk of a phishing attack under the circumstances, and attributes of the user or Computer 102. For example, the Authentication Appliance 140 may be able to select a more secure shared secret format if the user is using a different computer than what was used to initially register the user's identity, or Authentication Appliance 140 may be able to select a more convenient shared secret format when the likelihood of a phishing attack is low.

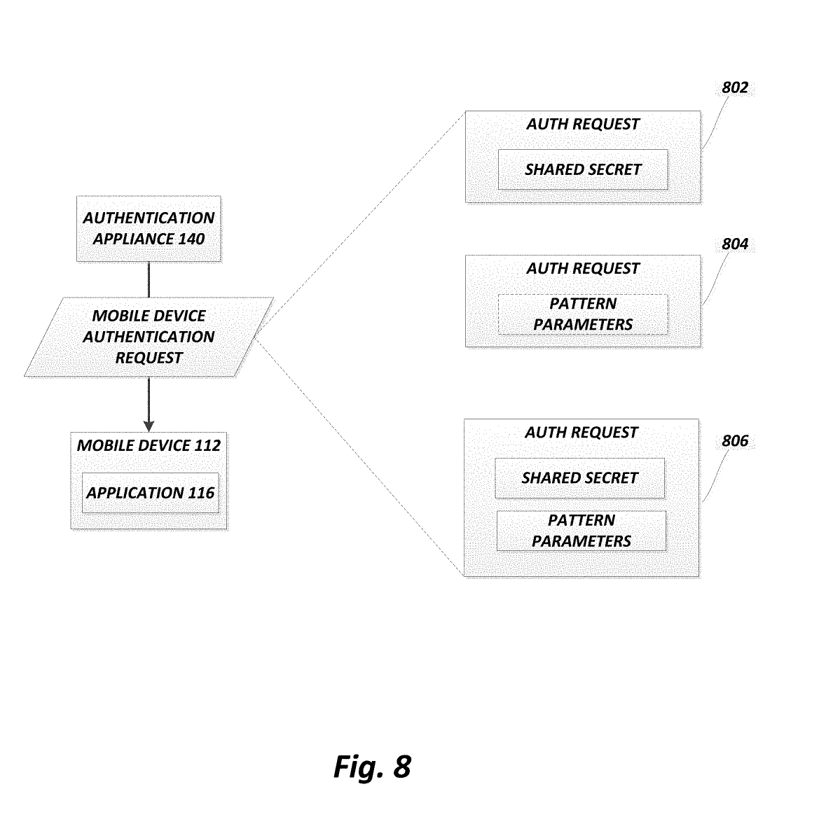

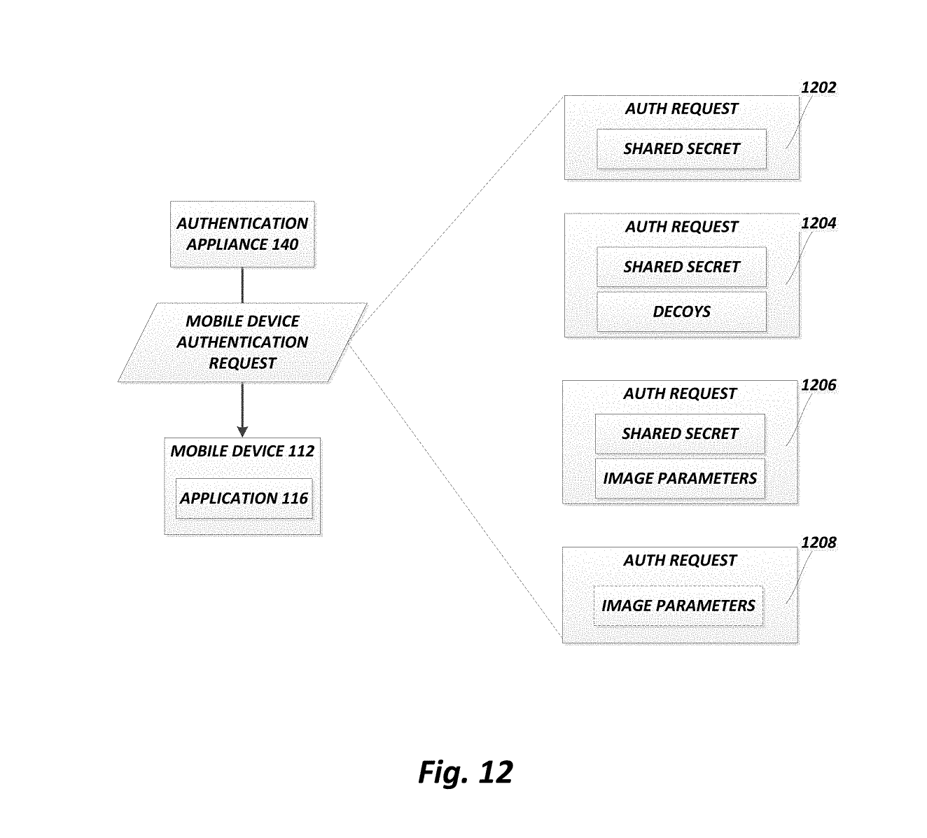

At Block 214, the Authentication Appliance 140 may provide Computer 102 with the shared secret for display on Computer 102, so that the user may view and become familiar with the shared secret. This will be the only channel through which the user may view the shared secret. In some configurations, Mobile Device 112 may also be “blind” to the shared secret. In these configurations, the shared secret is not provided to Mobile Device 112 ever. This may increase security by preventing the shared secret from being intercepted in a transmission from Authentication Appliance 140 to Mobile Device 112. Such embodiments are described in further detail in regards to FIG. 8 and FIG. 12.

At Block 216, the Authentication Appliance 140 may look up the Mobile Device 112 associated with the user identity. The Authentication Appliance 140 may already have done this previously. For example, if the reference user identities are in the same database as the phone numbers or mobile device identifiers associated with those user identities, then Authentication Appliance 140 could have retained the information associated with the Mobile Device 112 when it verified the user's identity. In some configurations, Authentication Appliance 140 may look up the Mobile Device 112 at Block 208 or Block 210 rather than at Block 216.

It should be noted that in some configurations, the phone number or mobile device identifier associated with the corresponding user credentials and/or profiles may be stored in a separate database from the user credentials. For example, Authentication Appliance 140 may have to look up the mobile device information using some kind of pointer.

At Block 218, Authentication Appliance 140 may send an authentication request to the Mobile Device 112 that is associated with the user identity. In some configurations, the authentication request may include a push notification sent from Authentication Appliance 140 to Mobile Device 112. The push notification may, upon opening, direct an Application 116 on Mobile Device 112 to open. The contents of the authentication request may vary across different embodiments. FIG. 8 and FIG. 12 illustrate some examples of some of the information that can be found in the mobile device authentication request.

In some configurations, the authentication request may need to be opened by the Application 116 within a set period of time, otherwise the authentication request may expire and the authentication process will have to be repeated so that a new request can be sent to Mobile Device 112. In some configurations, the shared key generated by the Authentication Appliance 140 may be configured to expire within a set period of time. Thus, even if the authentication request is opened the authentication process will fail if the shared key expires before the user can enter it into their Mobile Device 112.

In response to opening the authentication request, Application 116 may present an authentication user interface on the mobile device for obtaining the additional authentication factor. For example, if the shared secret is an image then Application 116 may present an authentication user interface displaying a bank of selectable images, with one of those images corresponding to the shared secret. As another example, if the shared secret is a pattern then Application 116 may present an authentication user interface having an interactive area for drawing the pattern, such as a pattern box or pattern lock.

In some configurations, Application 116 may be a web browser or configured to work with a separate browser. In such instances, Application 116 may direct the browser component to the URL of a web-based authentication service. The webpage may have the previously described authentication user interface for obtaining the additional authentication factor from the user. In some configurations, the URL may be sent in the authentication request. In some of such configurations, the URL may also be dynamically generated and the webpage at the URL may be configured to expire within a set period of time. Thus, if Application 116 is too slow in opening the authentication request, the webpage at the URL may be expired and the authentication process will have to be repeated.

At Block 220, the user may enter the shared secret into the authentication user interface presented on their Mobile Device 112. In some configurations, there may be a set time period in which the user may have to provide the shared secret. Otherwise, the shared secret may expire.

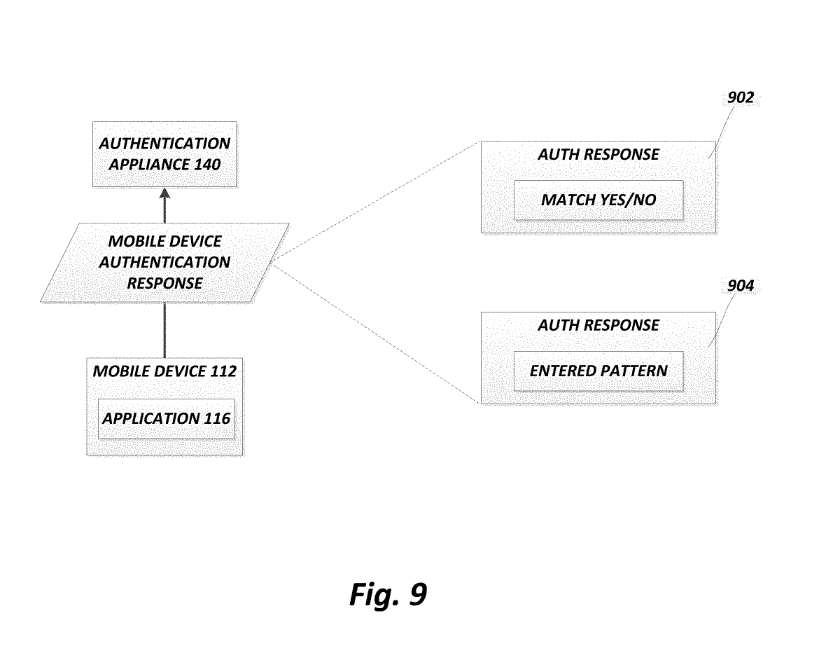

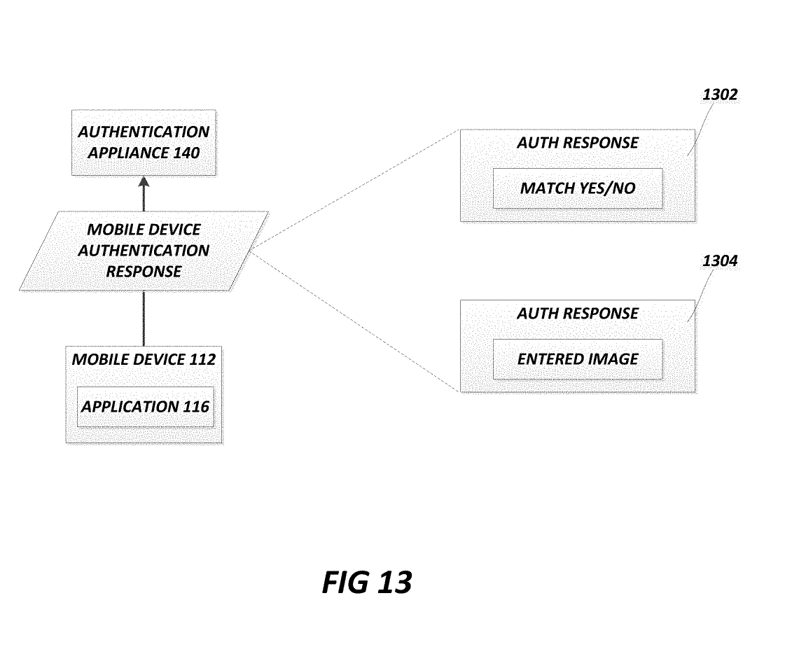

In some configurations, the Application 116 may be configured to send an authentication response to Authentication Appliance 140 once the user enters the shared secret. In some configurations, the Authentication Appliance 140 may wait for a response from Mobile Device 112. In some of such configurations, there may be a set time period in which the Mobile Device 112 has to provide a response. If that time period expires, the authentication process may need to be repeated. The contents of the authentication response are described in further detail in regards to FIG. 9 and FIG. 13.

At Block 222, Mobile Device 112 and/or Authentication Appliance 140 will compare the user-entered shared secret with the reference shared secret that was generated by Authentication Appliance 140 in Block 212. This comparison can be done by the Authentication Appliance 140, in which case the user-entered shared secret can be sent in an authentication response from Mobile Device 112 to Authentication Appliance 140. Alternatively, the comparison can be done client side by Mobile Device 112 if Mobile Device 112 knows the reference shared secret, in which case the authentication response from Mobile Device 112 to Authentication Appliance may inform of whether there was a match or not. If the user-entered shared secret matches the reference shared secret, then the authentication process is successful.

At Block 224, upon successful authentication, Authentication Appliance 140 may provide Computer 102 access to Protected Resource 130. The logistics for granting access to Protected Resource 130 may vary. In some embodiments, the Authentication Appliance 140 may provide credentials that are trusted by Protected Resource 130, which is configured to allow authenticated users by checking for the credentials. In some configurations, the credentials may be in the form of storable token(s) or identities that can be presented to Protected Resource 130. In some embodiments, the credentials may be a persistent token, while in other embodiments the credentials may be a temporary security token that is configured to be trusted by Protected Resource 130. If the access being granted is temporary, such as via a session token, then the user may need to go through the authentication process again if Computer 102 is turned off, Application 106 is logged out, and so forth. In comparison, persistent tokens may persist across longer sessions so that the user may not need to go through the authentication process every time.

The credentials may contain a cryptographic signature. By using public/private key encryption such as PKI, one can nearly guarantee that the Authentication Appliance 140 was the entity that issued the credentials. This enables the Protected Resource 130 to trust that the credentials presented by the Application 116 was issued by the Authentication Appliance 140. This signature is not strictly necessary, and trust in the credentials may be accomplished in other ways such as with a database lookup by Protected Resource 130 into a database associated with issued credentials, or other such method known to those in the art to further verify the credentials.

The credentials may comprise, by way of example, a userid in plain text or encrypted, a userid and a domain/organization (e.g. johndoe@company.com) in plain text or encrypted, an identity assertion in the form of SAML, OpenID, OpenID Connect, forms based authentication, lightweight third party authentication, an encrypted URL, encrypted HTTP headers or any another browser based form of identity, the time the token was created or delivered, and the expiration time of the token. In some configurations, the credentials may store the URL or domain name of the Authentication Appliance 140, as well as the authentication method involved in generating the credential. In some configurations, the format of the credentials may vary from application to application.

The credentials may be stored directly in memory on Computer 102, or in more complex data structures such as a relational database. In some configurations, the credentials may be universally stored in specific, known locations. This allows Protected Resource 130 to determine whether credentials already exist, and if not, direct Computer 102 to access the Authentication Appliance 140 to begin the authentication process.

At Block 226, the user would be able to access Protected Resource 130 on Computer 102. More specifically, from the user's perspective they would be using Application 106 to access the contents of Protected Resource 130.

With respect to FIG. 3, the previously described interactions between Protected Resource 130, Application 106 of Computer 102, Authentication Appliance 140, Database 142, and Application 116 of Mobile Device 112 are shown in a step-wise manner that may be easier to understand. However, the steps as described herein do not need to be performed in the specific order presented.

A user may direct Application 106 on Computer 102 to access Protected Resource 130 at (1). Protected Resource 130 may check the credentials available to Application 106 on Computer 102 and verify them. Verification may involve, but is not limited to, validating a cryptographic signature contained within the credentials, or performing a local or remote database lookup. Protected Resource 130 may also evaluate the credentials to assess time/expiration, permissions and access rights for the user, and so forth. Reasons for rejecting the credentials could include, by way of example, that it has expired or cannot be cryptographically validated. If Protected Resource 130 determines that that no credentials are available or acceptable, the user identity may need to be authenticated before the user can access Protected Resource 130. Protected Resource 130 may then direct Application 106 and/or Computer 102 to access the Authentication Appliance 140 at (2). In some configurations, the credentials available to Application 106 may only be temporary and valid only for the current session. In situations for which the credentials are not configured to persist between sessions, the user may always be required to go through the authentication process before they can access Protected Resource 130.

The user may then provide credentials associated with a user identity to Authentication Appliance 140 at (3). Examples of credentials associated with the user identity may include a username and password, a static PIN, a certificate registered to the user, a knowledge based answer, etc. In some configurations, the credentials may be sent through Application 106. Application 106 may be configured to pass credentials to the Authentication Appliance 140 directly over a client-server mechanism. For example, Application 106 may allow for webservices, REST calls, APIs or other mechanism that allow the credentials to be sent to Authentication Appliance 140. In some configurations, the user may be sending a selection of an authentication scheme to the Authentication Appliance 140.

Authentication Appliance 140 may then verify the user-supplied credentials using a variety of enterprise identity databases to verify a user's identity. Database 142 is an example of such an identity database, and can include, by way of example, SQL databases, Microsoft Active Directory servers, LDAP directories, Oracle ODBC servers, RADIUS servers, or any other on site or cloud database that stores user credentials or profiles. Each of these directories or authentication services can store information about the user's identity. Many of these databases also support authentication protocols.

One method for verification of a user's identity via the credentials passed to the Authentication Appliance 140 is to lookup the user's entry in Database 142 to check the status of the user's identity at (4). The information submitted by the user can be compared to the information located within the database. If the submitted information and database-resident information is identical or within select comparison parameters, then the user is considered to be who they claim to be and is considered verified.

With respect to FIG. 3, checking and receiving the status of the user's identity at (5) may comprise searching for a specific user in Database 142, receiving information about the user from the Database 142, such as a complete user entry or specific attributes about the user, and comparing the received data to the submitted information. Such interactions with Database 142 may be over a secure channel, such as SSL/TLS or any other data privacy mechanism. If the comparison indicated that the user submitted information that only the user would know, then the user may be considered verified.

Another method to authenticate a user is to perform an authentication exchange with the database. For example, LDAP directories, including Microsoft's Active Directory, support a variety of authentication mechanisms that can verify user passwords and credentials. Such an authentication exchange could be, by way of example, an, LDAP bind, or private/public key exchange. This method does not necessarily require transmission of the specific authentication information to the database. Instead, and as one skilled in the art would recognize, these methods may use encryption, nonces and hashes to determine whether the user has submitted the correct information.

In some configurations, the Authentication Appliance 140 may also determine which services or features on Protected Resource 130 that the user's identity may be permitted to access. Database 142 may contain specific attribute values associated with users that can be used to determine the specific servers, services, or features permitted to be used with each user identity. Authentication Appliance 140 may request this user specific data from Database 142, or another database affiliated with a specific server, service, or feature, to make this decision. Authentication Appliance 140 may factor in this decision later on when generating the credentials used to grant the user access to Protected Resource 130. The generated credentials may be interpreted by Protected Resource 130 to determine which services or features that the user should be allowed to access.

As part of the authentication of the user, Authentication Appliance 140 may require additional authentication to be performed, such as using a mobile device to provide additional authentication factors for enhanced security. This determination can be made, sometimes independently, depending on the user's selection of the authentication scheme, the configuration of policies on Authentication Appliance 140, or in consultation with configurations or policies stored in a database. For example, the user specific data in Database 142 may include authentication configurations or policies that can be associated with different users. In particular, Database 142 may store attribute associated with particular users that indicate a higher level of authentication is required. An example of an authentication scheme with enhanced security is the shared secret mobile device two-factor authentication scheme described herein.

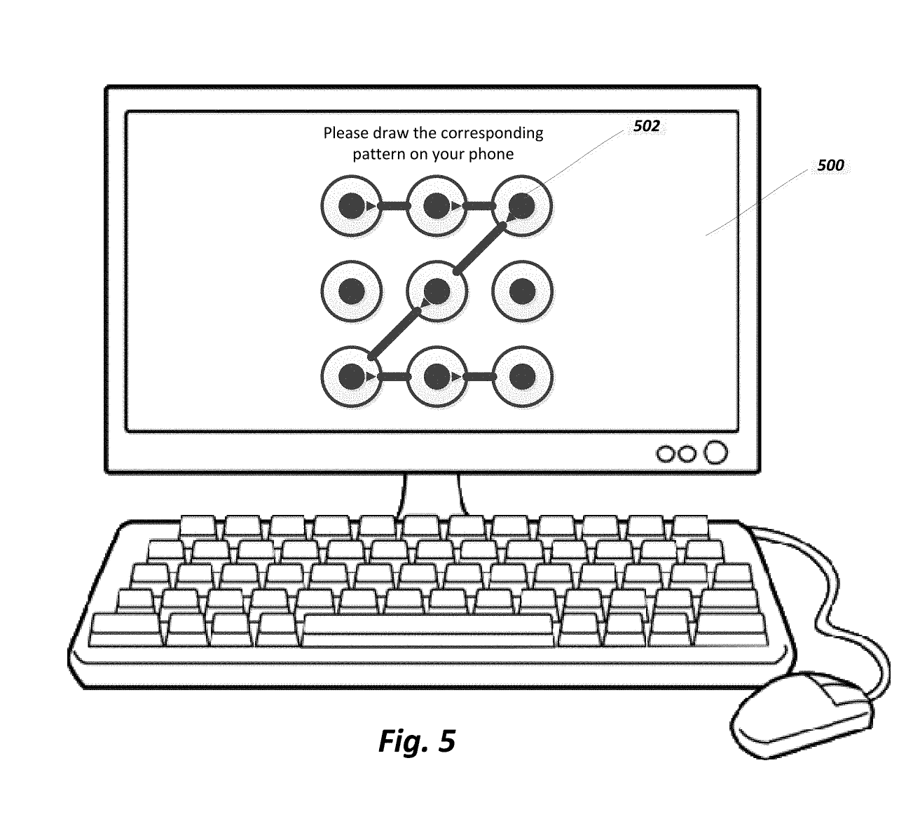

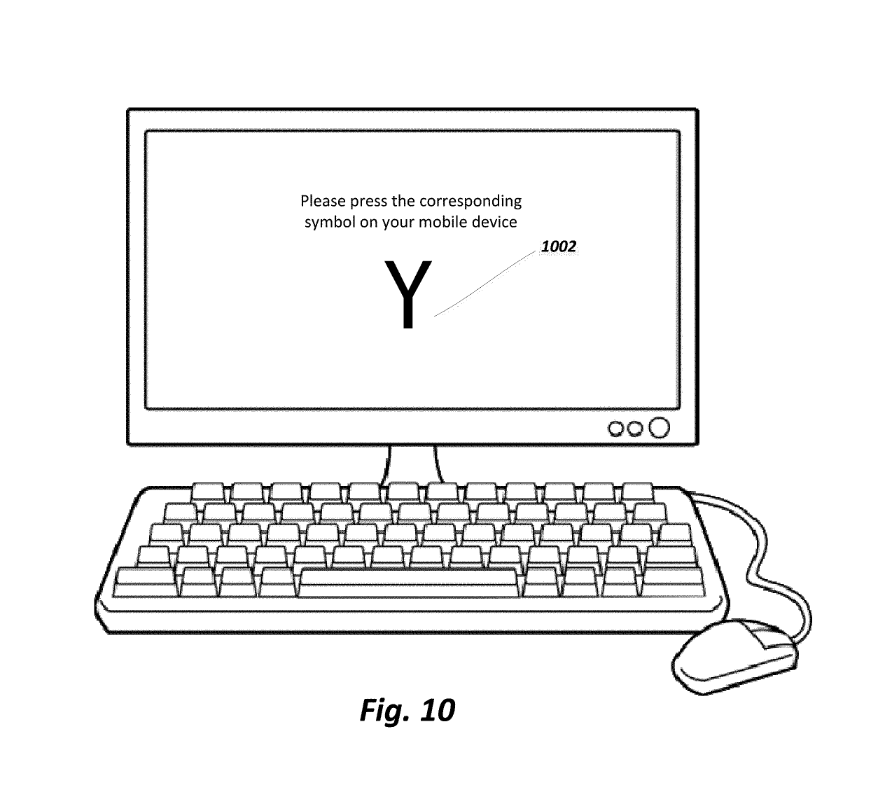

Authentication Appliance 140 may then generate a shared secret and send it Computer 102 to be displayed to the user at (6). As described previously, the shared secret could be an image, a pattern, a key, and so forth. Examples of secure shared secrets may include a specific image that may need to be selected among a plurality of images, or a pattern that the user may need to reproduce (such as drawing the appropriate pattern on a touchscreen pattern lock). In some configurations, the shared secret is dynamically generated for each authentication session. If the shared secret is a pattern, it may be displayed on Computer 102 via a user interface such as the one seen in FIG. 5. If the shared secret is an image, it may be displayed on Computer 102 via a user interface such as the one seen in FIG. 10.

In some configurations, the format and the parameters of the shared secret may be determined by Authentication Appliance 140, by evaluating information such as the configuration of policies on Authentication Appliance 140, the configuration of policies on Protected Resource 130, attributes of the user or Computer 102 that initiated the authentication process, and configurations or policies associated with different user identities (which may be stored in databases). For example, Authentication Appliance 140 may evaluate user specific data in Database 142 for attributes associated with particular users that indicate a higher level of phishing-prevention or security is required, and then Authentication Appliance 140 may generate a shared secret that is less likely to be guessed at random. In other configurations, Authentication Appliance 140 may be configured to only generate shared secrets of a certain format.

For shared secrets of a specific format, Authentication Appliance 140 may generate the shared secret within established parameters based on a pre-configured algorithm. For example, if the shared secret is a pattern designed to be drawn in a pattern box or pattern lock displayed on a touchscreen display, then the shared secret may be constrained by the dimensions of the pattern box, the number of strokes in the pattern, the requirement that the strokes be connected in a way that they can be drawn without the user lifting their finger off the touchscreen, and so forth. As previously described, some requirements (e.g., the dimensions of the pattern box and the number of strokes) may be flexible and can be changed for enhanced security or convenience. The Authentication Appliance 140 may then generate the pattern at random to be within the specified parameters. In other words, the population of possible patterns that the pattern is selected from may have a uniform distribution. However, the pattern need not be randomly generated within the parameters. Any method could be chosen. For example, the Authentication Appliance 140 may be configured to generate patterns that have a number of strokes ranging from four to six, but may prefer patterns with a higher number of strokes under certain circumstances. In this example, the number of possible pattern permutations can be increased without increasing the maximum number of strokes, which can be used to reduce the likelihood the shared secret is guessed at random depending on the circumstances.

In the example where the shared secret is an image designed to be selected in a bank of images, then Authentication Appliance 140 may not only need to generate the shared secret but also supply the other “decoy” images to fill up the bank of images. Thus, generation of the shared secret may be constrained by the overall pool of images, the number of images to be displayed, along with any additional constraints. These parameters can be changed for enhanced security or convenience. For example, the overall pool of images could be symbols, or by way of example, the letters of the alphabet and the numbers 0-9 such that there are thirty-six different images in the pool. If the number of images to be displayed in the bank is 9, then the number of 9 image combinations chosen from the pool of 36 images is tremendous. However, with 9 total images, the chance that a user randomly guesses the correct shared secret is 1 in 9. Increasing the total number of images in the displayed image bank would make it less likely that a user would randomly guess the shared secret, but could reduce the number of image combinations available in the pool of images. Within the specified parameters, Authentication Appliance 140 may generate the shared secret and decoy images at random. However, as previously described, the images do not need to be randomly selected and any method could be chosen. For example, Authentication Appliance 140 may be configured to prefer image combinations that avoid having both the digit zero, “0” and the letter, “O”, in the same combination, to prefer a certain image bank size within a range of sizes, or to prefer that the shared secret does not stand out (e.g., it is a number while the decoy images are all letters).

The parameters and constraints considered in generating other shared secret formats are not fully listed here, but can also be changed for enhanced security or convenience. Some example factors that affect how easily the shared secret may be guessed include the length of the shared secret, the total pool that the shared secret is generated from (in some cases like for a challenge-response, there may be multiple pools), the pool that the shared secret is selected from or the number of alternative selections, and so forth.

Authentication Appliance 140 may send a signal for initiating the authentication workflow to the Mobile Device 112 that has been identified as associated with the user's credentials and/or profile at (7). In some configurations, the phone number or device identification number of Mobile Device 112 may be stored within Database 142 and may be determined at some point during the verification of the user credentials.

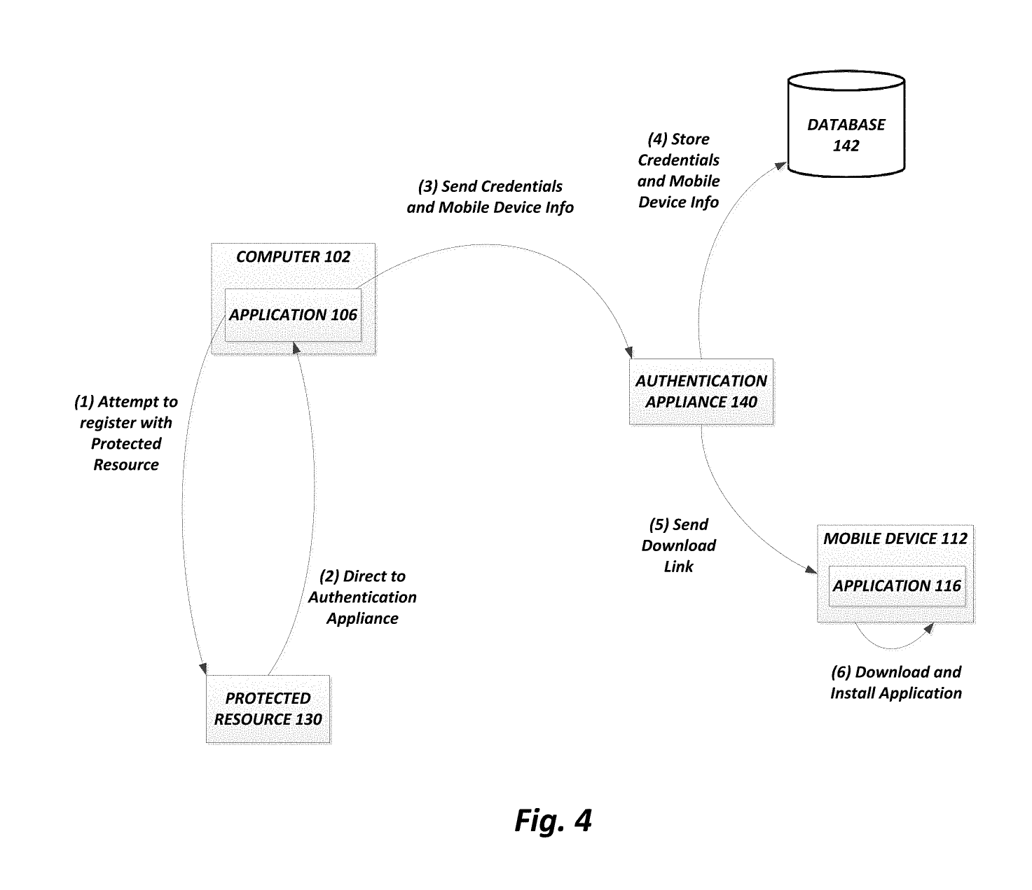

In some configurations, this signal may be an authentication request. In some of such configurations, the authentication request may be a push notification or prompt. The authentication request may be opened by Application 116 on Mobile Device 112. Application 116 may be a mobile application that was installed and configured prior to the authentication process, such as during the registration process illustrated in FIG. 4.

The format and contents of the authentication request may vary, depending on the information that Application 116 is provided. More specifically, the authentication request will vary depending on whether Application 116 is given the generated shared secret or if Application 116 knows how the shared secret is generated. Further details of the authentication request are provided in FIG. 8 and FIG. 12. In some configurations, authentication request may provide Application 116 with information needed to generate the authentication user interface on the Mobile Device 112 or specify how such an authentication user interface may look.

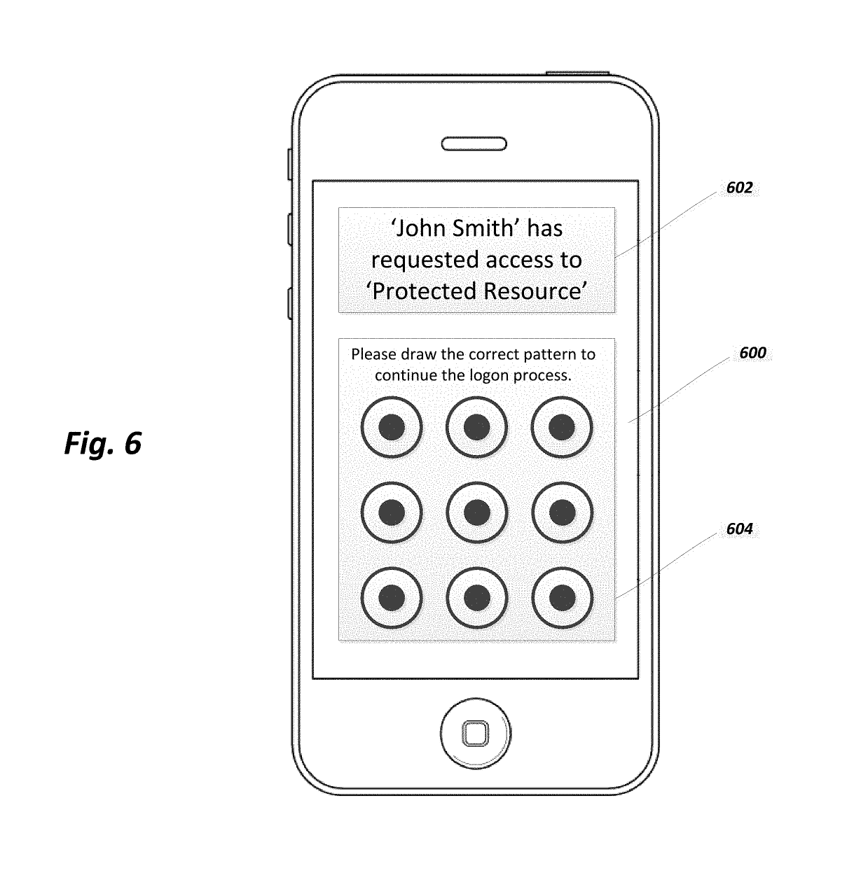

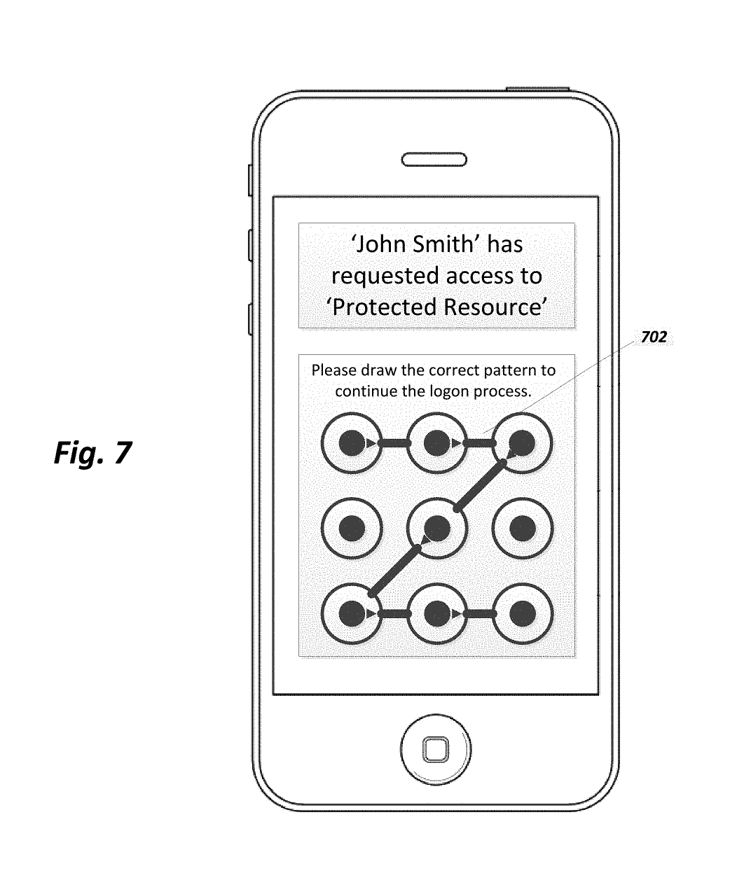

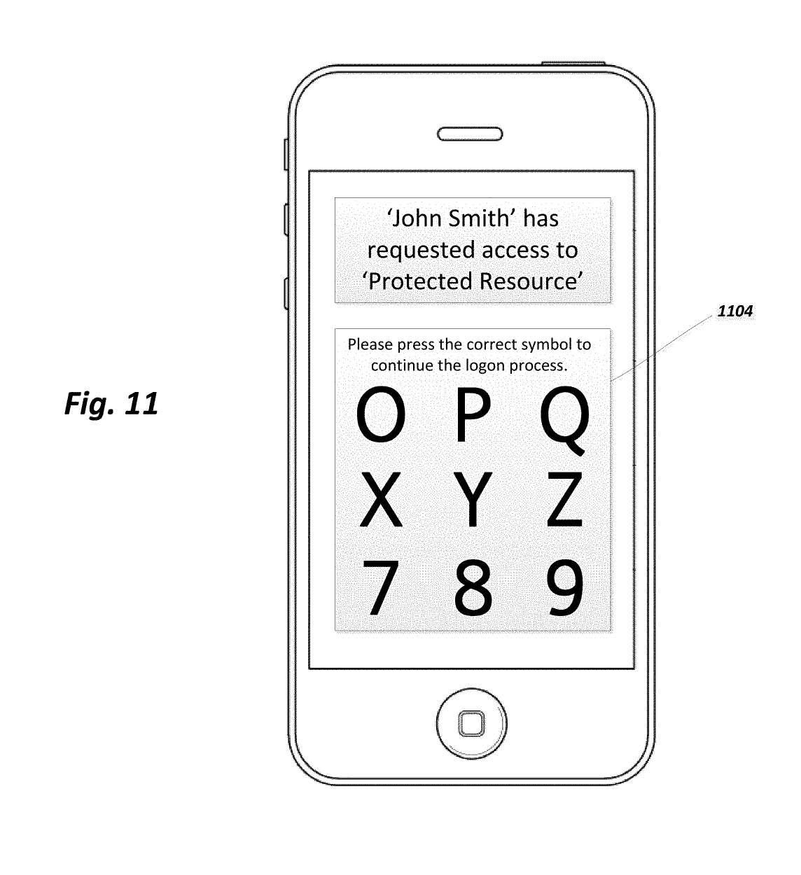

Upon opening the authentication request, Application 116 will display the authentication user interface to the user. The authentication user interface will have an interactive component that allows the user to enter, select, draw, or reproduce in the Mobile Device 112 what they believe the shared secret is. If the shared secret is a pattern, a pattern box or pattern lock may be presented to the user to draw the pattern as shown in FIG. 6 and FIG. 7. If the shared secret is an image, an image bank may be presented to the user to select the shared image over any decoy images as shown in FIG. 11.

The user enters, selects, draws, or reproduces what they believe the shared secret is into the prompt. Application 116 may then return an authentication response back to Authentication Appliance 140 at (8). The format and contents of the authentication response may vary depending on the information provided to Application 116, and whether the comparison of the user-entered secret and the reference shared secret takes place on Mobile Device 112. More information about authentication responses is provided in FIG. 9 and FIG. 13.

In some configurations, the authentication response sent to Authentication Appliance 140 will include the user-entered secret. Authentication Appliance 140 may then compare the user-entered secret to the reference shared secret that it generated.

It should be noted that in some configurations, Application 116 may comprise a browser or be configured to interact with a browser to perform web-based authentication upon opening the authentication request. For example, an application developer (or any other entity) could insert into Application 116 an authentication module that handles interaction with a browser. The authentication module can comprise snippets of code that, when compiled and executed, direct a web browser to access a specific URL, and/or receive data from the web browser, directly or indirectly, during the authentication process. Thus, Application 116 may direct the browser to a URL associated with web-based authentication, such as the URL of a web authentication server or Authentication Appliance 140. The authentication user interface may be integrated into a webpage, which may be part of Authentication Appliance 140 or configured to send the authentication response to Authentication Appliance 140 directly.

If the user-entered secret and the reference shared secret match, Authentication Appliance 140 may then grant Application 106 on Computer 102 access to Protected Resource 130 at (9). In some configurations, Authentication Appliance 140 may provide an identity or token to store on Computer 102 before re-directing Application 106 back to the Protected Resource 130. These identities or tokens may be presented to the Protected Resource 130 to gain access to some of the network-based application services provided by Protected Resource 130. In some configurations, the identity or token may even allow multiple applications (besides Application 106) on Computer 102 to access Protected Resource 130. In some configurations, the identity or token may even allow Application 106 or Computer 102 to access multiple protected resources that trust the identity or token.

FIG. 4 is an activity diagram illustrating some of the interactions between the components of one embodiment of the mobile device authentication system during the registration process. FIG. 4 is very similar to FIG. 3, and FIG. 4 may represent the registration process prior to performing the authentication process described in FIG. 3.The user may direct Application 106 of Computer 102 to access Protected Resource 130 at (1). However, the user does not have credentials allowing access Protected Resource 130, nor does the user have an established user identity with Authentication Appliance 140. In some configurations, the user may click a registration link or button provided by Protected Resource 130. Protected Resource 130 then directs Application 106 to the Authentication Appliance to begin the registration process at (2). The user may then provide their user credentials to Authentication Appliance 140 at (3). The user may also provide their mobile device info, such as a phone number associated with their Mobile Device 112, in order to enable mobile device based two-factor authentication.

Authentication Appliance 140 may create an authorized user identity by storing the user credentials and mobile device info within an identity database, such as Database 142, at (4). The mobile device info is associated with the user identity to be used in future authentications.

Once the user identity is established, Authentication Appliance may optionally send Mobile Device 112 a download link to Application 116, such as via SMS, at (5). The user may open the link on their Mobile Device 112 or the user may choose to find Application 116 for download on the Internet. The user downloads and installs Application 116 on Mobile Device 112 at (6). Application 116 may be configured, or come pre-configured, to receive authentication requests such as push notifications from Authentication Appliance 140 in order to carry out the mobile device portion of the authentication process.

### III. Pattern-Based Shared Secret Implementation (FIGS. 5-9)

FIG. 5 is an example user interface for viewing a pattern on a computing device.

FIG. 5 depicts one embodiment of Computer 102, although Computer 102 can be any computing device capable of accessing Protected Resource 130.

Shown on the display of Computer 102 is a Sharing User Interface 500, in which the shared secret generated by Authentication Appliance 140 is provided to the user to view. As can be seen from the figure, the shared secret is Pattern 502. Pattern 502 is a connective pattern in a 3×3 pattern box that has a “Z” shape and starts from the top-left portion of the pattern box. Instructions are provided to the user draw the corresponding pattern on their phone or Mobile Device 112. This is the only time that the user will see Pattern 502. In a phishing scenario, Sharing User Interface 500 would be seen by the malicious user with stolen credentials but not the actual user associated with Mobile Device 112, which is presumed to be in the possession of the actual user.

FIG. 6 is an example user interface for requesting a pattern be drawn on a mobile device.

FIG. 6 depicts an embodiment of Mobile Device 112, although Mobile Device 112 can be any computing device capable of carrying out the mobile device portion of the authentication process, except it cannot be the same device as Computer 102.

Shown on the display of Mobile Device 112 is an Authentication User Interface 600 generated by an Application 116 running on Mobile Device 112. Authentication User Interface 600 is shown as having a Prompt 602 and an Interactive Portion 604.

Prompt 602 informs the user that the user identity “John Smith” has requested access to “Protected Resource” and initiated the authentication process. Prompt 602 informs the user of Mobile Device 112 the circumstances of the authentication request received by Application 116.

Interactive Portion 604 can instruct the user on what action needs to be performed in order to complete the authentication process. Here, it requests the user to draw the correct pattern. Interactive Portion 604 also has a pattern box or pattern lock, on which the user may draw the shared secret pattern that was displayed on Computer 102, as demonstrated in FIG. 5.

FIG. 7 illustrates the example user interface in FIG. 6 after a pattern has been drawn.

Authentication User Interface 600 from FIG. 6 is still visible in FIG. 7. The only difference is that the user has drawn Pattern 702 in in the Interactive Portion 604. Pattern 702 is a “Z” shape pattern starting from the top-left of the pattern box. Since Pattern 702 entered by the user on Mobile Device 112 matches the Pattern 502 displayed on Computer 102, this would result in a match and “John Smith” being granted access to “Protected Resource” on Computer 102.

FIG. 8 is a block diagram that illustrates various example contents of a pattern-based authentication request sent to a mobile device.

Authentication Appliance 140 sends an authentication request to Mobile Device 112 during the authentication process. In some cases, the authentication request is a push notification that can be received by Application 116. However, the format and contents of the authentication request can vary depending on the shared secret format, what information is available to Application 116, and the role Application 116 is configured for.

FIG. 8 shows three example authentication requests, Request 802, Request 804, and Request 806, that can be sent when the shared secret format is a pattern, such as the pattern depicted in FIG. 5.

Request 802 may be used in scenarios where Application 116 is provided the shared secret, and in which the parameters of the shared secret do not change. For example, Authentication Appliance 140 may send the Application 116 information that represents the specific, generated pattern. That pattern can be conveyed in many ways. For example, one way would be to actually send a graphical representation of the generated pattern. That graphical representation can be compared to a graphical representation of the user-entered pattern. Another way would be to represent the pattern symbolically. For example, each of the 9 coordinates in the 3×3 pattern box can be assigned a number 1-9. The pattern can be conveyed as a sequence of numbers corresponding to the coordinates and the order they engaged. As an example, if the top row of coordinates from left to right is assigned 1, 2, and 3, and so forth, then the sequence representing the “Z” shape pattern shown in FIG. 5 would be 1, 2, 3, 5, 7, 8, 9. The pattern can be conveyed in a way that reduces the amount of information required. Any convention for referencing a pattern can be used, so long as it is adhered to by both Application 116 and Authentication Appliance 140.

The benefit of providing Application 116 the shared secret in this scenario is that it also knows the user-entered secret. Comparison between the shared secret and the user-entered secret can be performed client-side and on Mobile Device 112, rather than with Authentication Appliance 140. For example, Application 116 could check to see if the sequence of the pattern entered by the user matches the sequence received from the Authentication Appliance 140. Mobile Device 112 would only need to return a response to Authentication Appliance 140 that signaled whether there was a match or no match.

This approach may also save time or reduce transmission size, at the expense of flexibility. In the example provided, the authentication request contained only a seven-digit sequence representing the pattern. Thus, authentication request can be performed with a relatively small amount of data, which may be advantageous since Mobile Device 112 can be on a telecommunications network. However, since the reference convention must be adhered to by both Application 116 and Authentication Appliance 140, it would be difficult to change some of the parameters of the patterns. In this example, it would be OK if Authentication Appliance 140 generated patterns with a different number of strokes. The sequence of the authentication request could simply have a different length corresponding to the number of strokes. However, Authentication Appliance 140 would not be able to change the dimensions of the pattern since the sequence may be agnostic with respect to the dimensions of the pattern. Application 116 and Authentication Appliance 140 would have to be in agreement beforehand on the dimensions of the pattern (e.g., that the patterns are drawn in a 3×3 box).

Request 804 may be used in scenarios where Application 116 is optionally provided only the parameters involved in generating the interactive portion of its authentication user interface. However, it should be noted that some or all of these parameters may be determined in advance and fixed within Application 116 so that they never change. For example, Authentication Appliance 140 may send the Application 116 information that the shared secret is a connective pattern drawn in a 3×3 pattern box, has a certain number of strokes (e.g., the length of the pattern), and can be replicated without lifting the finger on a touchscreen, Using these parameters, Application 116 knows to draw a 3×3 pattern box and also when to send a response based on how long it expects the pattern to be. Alternatively, Application 116 may have been designed only with a 3×3 pattern box in mind so that parameter may be a fixed part of Application 116. If all the parameters used to define the shared secret and the interactive portion of Application 116 are fixed in this way, then Request 804 may convey no information except that the user identity is attempting to authenticate to access the protected resource.

The benefit of keeping Application 116 “blind” to the shared secret in this scenario is that it provides enhanced security because it restricts the information a malicious user obtains from intercepting the transmission between the Authentication Appliance 140 and Application 116. The comparison between the user-entered pattern and the shared secret is done solely by Authentication Appliance 140.

This approach may also allow Authentication Appliance 140 to change the format of the shared secret on-the-fly. For example, Authentication Appliance 140 may be able ramp up security against phishing attacks by making the shared secret harder for a user to randomly guess. If there is an increased chance of phishing, then the Authentication Appliance 140 may be able to generate a more complex pattern such as a 4×4 pattern. Those parameters could be sent to Application 140, which would present a 4×4 pattern box in the interaction portion of the authentication user interface. The shared secret could also be switched from a pattern format to an image format, and so forth, assuming Application 116 could generate the different interactive portions required.

Request 806 can be understood as a hybrid between the two approaches, in which the shared secret and associated parameters are sent to Application 116. Application 116 can handle client-side verification of the user-entered secret and may also be able handle different shared secret formats.

FIG. 9 is a block diagram that illustrates various example contents of a pattern-based authentication response sent from a mobile device.

After the user enters the shared pattern into Mobile Device 112, the Mobile Device 112 may send an authentication response to Authentication Appliance 140 in order to complete the authentication process.

FIG. 9 shows two example authentication responses, Response 902 and Response 904, which can be sent when the shared secret format is a pattern, such as the pattern depicted in FIG. 5.

Response 902 can be used in client-side verification scenarios where the Application 116 knows the shared secret and verifies the user-entered secret against the shared secret. Application 116 determines whether there is a match or not, and then provides the results to Authentication Appliance 140. If there is a match, Authentication Appliance 140 will provide Computer 102 access to Protected Resource 130.

Response 904 can be used in all other scenarios where the Authentication Appliance 140 compares the user-entered secret against the generated shared secret. Application 116 sends only the user-entered secret in Response 904, which is received by Authentication Appliance 140. If Authentication Appliance 140 can successfully match the user-entered secret against the generated shared secret, then access is provided to Protected Resource 130.

### IV. Image-Based Shared Secret Implementation (FIGS. 10-13)

FIG. 10 is an example user interface for viewing an image on a computing device.

FIG. 10 depicts one embodiment of Computer 102, although Computer 102 can be any computing device capable of accessing Protected Resource 130.

Shown on the display of Computer 102 is a Sharing User Interface 500, in which the shared secret generated by Authentication Appliance 140 is provided to the user to view. As can be seen from the figure, the shared secret is Image 1002. Image 1002 is the letter “Y”. Instructions are provided to the user press the corresponding symbol on their phone or Mobile Device 112. This is the only time that the user will see Image 1002. In a phishing scenario, Sharing User Interface 1000 would be seen by the malicious user with stolen credentials but not the actual user associated with Mobile Device 112, which is presumed to be in the possession of the actual user.

FIG. 11 is an example user interface for requesting a pattern be drawn on a mobile device.

FIG. 11 depicts an embodiment of Mobile Device 112, although Mobile Device 112 can be any computing device capable of carrying out the mobile device portion of the authentication process, except it cannot be the same device as Computer 102.

Similar to FIG. 6, shown on the display of Mobile Device 112 is an Authentication User Interface 600 generated by an Application 116 running on Mobile Device 112. Authentication User Interface 600 has the same Prompt 602 to inform the user that the user identity “John Smith” has requested access to “Protected Resource” and initiated the authentication process.

However, Authentication User Interface 600 now has Interactive Portion 1104. Interactive Portion 1104 instructs the user to press the correct symbol to complete the authentication process. Interactive Portion 1104 has an image bank for displaying a plurality of selectable images. In particular, Interactive Portion 1104 illustrates a bank of nine images of symbols. The user may select one of the images as the shared secret image that was displayed on Computer 102, as demonstrated in FIG. 10.

If the user selects the image of the letter “Y” in the middle of the bank, that selected image would match the shared secret image and would result in “John Smith” being granted access to “Protected Resource” on Computer 102.

FIG. 12 is a block diagram that illustrates various example contents of an image-based authentication request sent to a mobile device.

Authentication Appliance 140 sends an authentication request to Mobile Device 112 during the authentication process. In some cases, the authentication request is a push notification that can be received by Application 116. However, the format and contents of the authentication request can vary depending on the shared secret format, what information is available to Application 116, and the role Application 116 is configured for.

FIG. 12 shows four example authentication requests, Request 1202, Request 1204, Request 1206, and Request 1208, which can be sent when the shared secret format is an image selected in a bank of images, as depicted in FIG. 11.

Request 1202 may be used in scenarios where Application 116 is provided the shared secret, and in which the parameters of the shared secret do not change. For example, Authentication Appliance 140 may send the Application 116 information that represents the specific image selected as the shared secret. The shared secret can be conveyed in many ways. For example, the actual image could be sent and Application 116 could retain the image of every image in the pool that the shared secret is selected from. Images can then be compared directly; the selected image may be compared against the actual shared secret image to determine a match. Another way may be to send a text-based representation or description of the shared secret. For example, if the image is the letter “Y”, then Request 1202 may indicate that the shared secret is “Y”, or if the image is a picture of a tree, then Request 1202 may indicate that the shared secret is “tree”. Application 116 would then either know to display that associated image or generate it visually in the interface. Any convention for referencing the image can be used, so long as it is adhered to by both Application 116 and Authentication Appliance 140.

Since only the shared secret is being sent in Request 1202, the Application 116 would have to know how to generate decoys beforehand. For example, Application 116 could be pre-configured with the knowledge that the total pool from which the shared secret is generated includes alphabetical letters and numbers 0-9. Then, Application 116 would know that if it received the letter “Y” as the shared secret to generate decoys using the remaining 35 symbols in the pool other than “Y”. Or the image bank may be static and limited to what is shown in the interface. For example, as shown in FIG. 11, the total pool of images could just be symbols “O”, “P”, “Q”, “X”, “Y”, “Z”, “7”, “8”, “9” and the shared secret would have to be one of those symbols.

Again, the benefit of providing Application 116 the shared secret is that Application 116 would be able to perform client-side verification of the user-selected image. Application 116 would then return a response to Authentication Appliance 140 that signaled whether there was a math or no match.

The transmission size of the authentication request is also reduced, at the expense of flexibility. In the example provided, an authentication request may only need to inform Application 116 that the shared secret is the letter “Y”. Application 116 would generate some combination of the shared secret and decoys to be displayed to the user. However, it could be difficult to change some of the parameters of the shared secret. For example, Application 116 would have to be aware of the total pool from which the shared secret and the decoys are drawn from. As a very specific example, Authentication Appliance 140 would not be able to send a punctuation mark symbol as the only content of Request 1202 if Application 116 was not pre-configured to accept that symbol.

Compare this to Request 1208, in which only information about the image parameters are sent to Application 116, or those image parameters are pre-configured within Application 116. For example, Authentication Appliance 140 may send Application 116 information that the image bank displayed will be 9 images and the total pool of selectable images will include numbers from 1 to 9. Or Application 116 may already know this information if it was pre-configured with those parameters in mind. With these parameters, Application 116 knows to display the numbers 1 to 9 in a selectable image bank containing 9 images.

Again, the benefit of keeping Application 116 “blind” to the shared secret is that it provides enhanced security because it restricts the information a malicious user obtains from intercepting the transmission between the Authentication Appliance 140 and Application 116. Application 116 does not know what the shared secret is and will only be able to report back to Authentication Appliance 140 what the user selected.

Requests 1204 and 1206 strike a middle ground between sending only the shared secret or sending only parameters.

Request 1204 sends both the shared secret along with the decoy images in the image bank. For example, to generate the interface shown in FIG. 11, Authentication Appliance 140 would send Request 1204 instructing Application 116 to display “O”, “P”, “Q”, “X”, “Y”, “Z”, “7”, “8”, “9” with an indication that “Y” is the shared secret.

Application 116 is able to perform client-side verification of the user-entered secret. Furthermore, the approach allows a certain degree of flexibility. For example, if more or less than nine images are sent, Application 116 may be configured to adjust the size of the image bank accordingly. However, Authentication Appliance 140 is now tasked with generating the decoys.

Request 1206 sends the shared secret along with image parameters. For example, Request 1206 could indicate to Application 116 that the image bank has 9 images, that “Y” is the shared secret, and to generate the remaining images in the bank using the other letters in the alphabet.

Application 116 is able to perform client-side verification of the user-entered secret. This approach also allows for some flexibility because Authentication Appliance 140 could issue different parameters. For example, Request 1206 may instruct Application 116 to use a larger image bank or generate decoys from a larger pool of images if there is an elevated threat of phishing.

FIG. 13 is a block diagram that illustrates various example contents of an image-based authentication response sent from a mobile device.

After the user selects the shared pattern into Mobile Device 112, the Mobile Device 112 may send an authentication response to Authentication Appliance 140 in order to complete the authentication process.

FIG. 13 shows two example authentication responses, Response 1302 and Response 1304, which can be sent when the shared secret format is an image. As can be seen, FIG. 13 is very similar to FIG. 9.

Response 1302 can be used in client-side verification scenarios where the Application 116 knows the shared secret and verifies the user-entered secret against the shared secret. Since Application 116 determines whether there is a match or not, it only needs to provide the verification results to Authentication Appliance 140.

Response 1302 can be used when Application 116 is “blind” and Authentication Appliance 140 is tasked with comparing the user-entered secret against the generated shared secret. Application 116 sends only the user-entered secret in Response 904, which is received by Authentication Appliance 140.

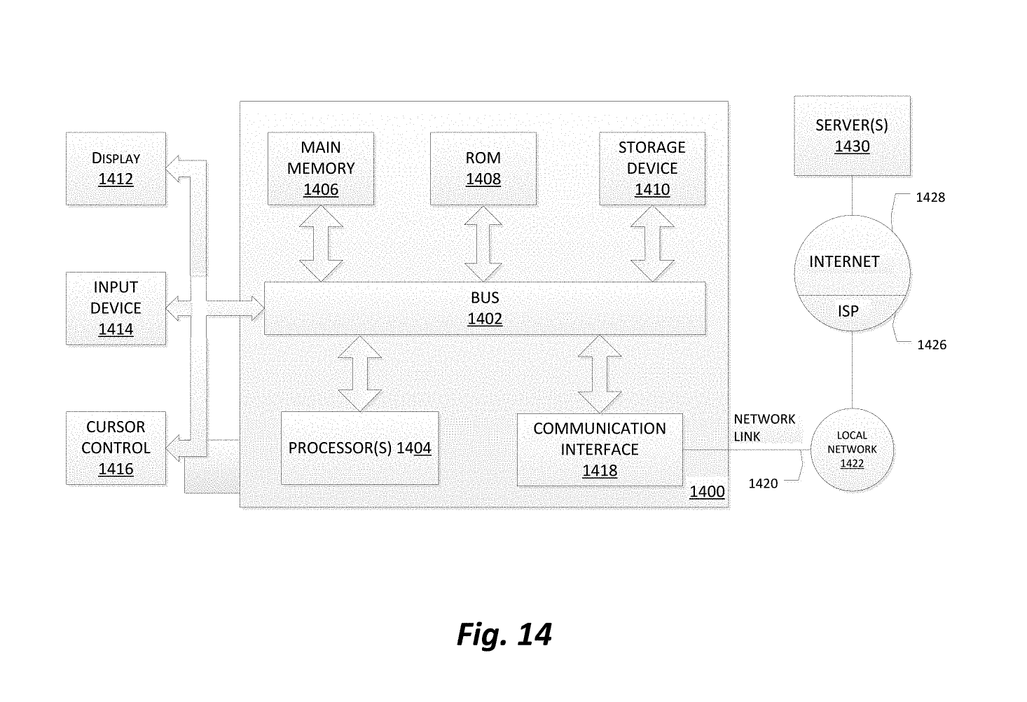

### V. Example Computing System (FIG. 14)

FIG. 14 is a block diagram that illustrates a computer system 1400 upon which an embodiment may be implemented. For example, any of the computing devices discussed herein, such as the appliance or any client computing devices may include some or all of the components and/or functionality of the computer system 1400.

Computer system 1400 includes a bus 1402 or other communication mechanism for communicating information, and a hardware processor, or multiple processors, 1404 coupled with bus 1402 for processing information. Hardware processor(s) 1404 may be, for example, one or more general purpose microprocessors.

Computer system 1400 also includes a main memory 1406, such as a random access memory (RAM), cache and/or other dynamic storage devices, coupled to bus 1402 for storing information and instructions to be executed by processor 1404. Main memory 1406 also may be used for storing temporary variables or other intermediate information during execution of instructions to be executed by processor 1404. Such instructions, when stored in storage media accessible to processor 1404, render computer system 1400 into a special-purpose machine that is customized to perform the operations specified in the instructions.

Computer system 1400 further includes a read only memory (ROM) 1408 or other static storage device coupled to bus 1402 for storing static information and instructions for processor 1404. A storage device 1410, such as a magnetic disk, optical disk, or USB thumb drive (Flash drive), etc., is provided and coupled to bus 1402 for storing information and instructions.

Computer system 1400 may be coupled via bus 1402 to a display 1412, such as a cathode ray tube (CRT) or LCD display (or touch screen), for displaying information to a computer user. An input device 1414, including alphanumeric and other keys, is coupled to bus 1402 for communicating information and command selections to processor 1404. Another type of user input device is cursor control 1416, such as a mouse, a trackball, or cursor direction keys for communicating direction information and command selections to processor 1404 and for controlling cursor movement on display 1412. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

Computing system 1400 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage

Computer system 1400 may implement the techniques described herein using customized hard-wired logic, one or more ASICs or FPGAs, firmware and/or program logic which in combination with the computer system causes or programs computer system 1400 to be a special-purpose machine. According to one embodiment, the techniques herein are performed by computer system 1400 in response to hardware processor(s) 1404 executing one or more sequences of one or more instructions contained in main memory 1406. Such instructions may be read into main memory 1406 from another storage medium, such as storage device 1410. Execution of the sequences of instructions contained in main memory 1406 causes processor(s) 1404 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1410. Volatile media includes dynamic memory, such as main memory 1406. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1402. Transmission media can also take the form of acoustic or light waves, such as those generated during radio-wave and infra-red data communications.

Various forms of media may be involved in carrying one or more sequences of one or more instructions to processor 1404 for execution. For example, the instructions may initially be carried on a magnetic disk or solid state drive of a remote computer. The remote computer can load the instructions into its dynamic memory and send the instructions over a telephone line using a modem or other network interface, such as a WAN or LAN interface. A modem local to computer system 1400 can receive the data on the telephone line and use an infra-red transmitter to convert the data to an infra-red signal. An infra-red detector can receive the data carried in the infra-red signal and appropriate circuitry can place the data on bus 1402. Bus 1402 carries the data to main memory 1406, from which processor 1404 retrieves and executes the instructions. The instructions received by main memory 1406 may retrieve and execute the instructions. The instructions received by main memory 1406 may optionally be stored on storage device 1410 either before or after execution by processor 1404.

Computer system 1400 also includes a communication interface 1418 coupled to bus 1402. Communication interface 1418 provides a two-way data communication coupling to a network link 1420 that is connected to a local network 1422. For example, communication interface 1418 may be an integrated services digital network (ISDN) card, cable modem, satellite modem, or a modem to provide a data communication connection to a corresponding type of telephone line. As another example, communication interface 1418 may be a local area network (LAN) card to provide a data communication connection to a compatible LAN (or WAN component to communicated with a WAN). Wireless links may also be implemented. In any such implementation, communication interface 1418 sends and receives electrical, electromagnetic or optical signals that carry digital data streams representing various types of information.

Network link 1420 typically provides data communication through one or more networks to other data devices. For example, network link 1420 may provide a connection through local network 1422 to a host computer 1424 or to data equipment operated by an Internet Service Provider (ISP) 1426. ISP 1426 in turn provides data communication services through the world wide packet data communication network now commonly referred to as the “Internet” 1428. Local network 1422 and Internet 1428 both use electrical, electromagnetic or optical signals that carry digital data streams. The signals through the various networks and the signals on network link 1420 and through communication interface 1418, which carry the digital data to and from computer system 1400, are example forms of transmission media.

Computer system 1400 can send messages and receive data, including program code, through the network(s), network link 1420 and communication interface 1418. In the Internet example, a server 1430 might transmit a requested code for an application program through Internet 1428, ISP 1426, local network 1422 and communication interface 1418.

The received code may be executed by processor 1404 as it is received, and/or stored in storage device 1410, or other non-volatile storage for later execution.

### Implementation & Additional Aspects

Each of the processes, methods, and algorithms described in the preceding sections may be embodied in, and fully or partially automated by, code modules executed by one or more computer systems or computer processors comprising computer hardware. The processes and algorithms may alternatively be implemented partially or wholly in application-specific circuitry. The disclosed processes may be performed under control of software executed by one or more computing devices, each of which may include a processor and memory.

Thus, while the foregoing is directed to various embodiments, other and further embodiments may be devised without departing from the basic scope thereof. For example, aspects of the present disclosure may be implemented in hardware or software or in a combination of hardware and software. An embodiment of the disclosure may be implemented as a program product for use with a computer system. The program(s) of the program product define functions of the embodiments (including the methods described herein) and may be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., hard-disk drive or any type of solid-state random-access semiconductor memory) on which alterable information is stored. Each of the processes, methods, and algorithms described in the preceding sections may be embodied in, and fully or partially automated by, code modules executed by one or more computer systems or computer processors comprising computer hardware. The processes and algorithms may alternatively be implemented partially or wholly in application-specific circuitry.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

The term “comprising” as used herein should be given an inclusive rather than exclusive interpretation. For example, a general purpose computer comprising one or more processors should not be interpreted as excluding other computer components, and may possibly include such components as memory, input/output devices, and/or network interfaces, among others.

What is claimed is:

1. A computing appliance for performing multi-factor authentication, the appliance comprising:
one or more processors;
a computer-readable memory; and
an authentication program comprising executable instructions stored in the computer-readable memory, wherein the executable instructions direct the one or more processors to at least:
obtain a set of user credentials from a client computer, wherein the set of user credentials are associated with a user identity;
access a database containing a set of reference user credentials;
verify the user identity by comparing the set of user credentials with the set of reference user credentials;
determine a mobile device associated with the user identity;
generate a shared secret;
transmit the shared secret to the client computer to be displayed on the client computer;
transmit an authentication request to the mobile device, wherein the authentication request is configured to be accessed by an application on the mobile device in order to obtain a user-supplied secret;
obtain an authentication response from the mobile device;
upon obtaining the authentication response, verify the user-supplied secret matches the shared secret; and
upon verifying that the user-supplied secret matches the shared secret, provide the client computer access to a protected resource.

2. The computing appliance of claim 1, wherein the shared secret comprises a pattern.

3. The computing appliance of claim 1, wherein the shared secret comprises an image.

4. The computing appliance of claim 1, wherein the authentication request comprises a push notification.

5. The computing appliance of claim 1, wherein the authentication response comprises the user-supplied secret, and wherein to verify that the user-supplied secret matches the shared secret, the executable instructions further direct the one or more processors to compare the user-supplied secret from the authentication response with the shared secret.

6. The computing appliance of claim 1, wherein the authentication response comprises an indication that the user-supplied secret matches the shared secret, and wherein to verify that the user-supplied secret matches the shared secret, the executable instructions further direct the one or more processors to assess the indication in the authentication response.

7. The computing appliance of claim 1, wherein the mobile device comprises a smart phone or a mobile phone.

8. The computing appliance of claim 1, wherein the authentication request comprises information associated with the shared secret.

9. A computerized method for performing multi-factor authentication, the method comprising:
by one or more hardware processors executing computing instructions:
receiving a set of user credentials from a client computer, wherein the set of user credentials are associated with a user identity;
accessing a database containing a set of reference user credentials;
verifying the user identity by comparing the set of user credentials with the set of reference user credentials;
determining a mobile device associated with the user identity;
generating a shared secret;
transmitting the shared secret to the client computer to be displayed on the client computer;
transmitting an authentication request to the mobile device, wherein the authentication request is configured to be accessed by an application on the mobile device in order to obtain a user-supplied secret;
receiving an authentication response from the mobile device;
upon receiving the authentication response, verifying the user-supplied secret matches the shared secret; and
upon verifying that the user-supplied secret matches the shared secret, providing the client computer access to a protected resource.

10. The computerized method of claim 9, wherein the shared secret comprises a pattern.

11. The computerized method of claim 9, wherein the shared secret comprises an image.

12. The computerized method of claim 9, wherein the authentication response comprises the user-supplied secret, and wherein the method further comprises comparing the user-supplied secret from the authentication response with the shared secret.

13. The computerized method of claim 9, wherein the authentication response comprises an indication that the user-supplied secret matches the shared secret, and wherein the method further comprises assessing the indication in the authentication response.

14. The computerized method of claim 9, wherein the mobile device comprises a smart phone or a mobile phone.

15. The computerized method of claim 9, wherein the authentication request comprises information associated with the shared secret.

16. A non-transitory computer storage medium which stores a mobile client application comprising executable code that directs a mobile device to perform a process comprising:
accessing an authentication request transmitted from an authentication appliance, wherein the authentication appliance is configured to:
obtain a set of user credentials from a client computer, wherein the set of user credentials are associated with a user identity;
access a database containing a set of reference user credentials;
verify the user identity by comparing the set of user credentials with the set of reference user credentials;
determine the mobile device, wherein the mobile device is associated with the user identity;
generate a shared secret;
transmit the shared secret to the client computer to be displayed on the client computer;
transmit the authentication request to the mobile device, wherein the authentication request is configured to be accessed by the application in order to obtain a user-supplied secret;
obtain an authentication response from the mobile device;
upon obtaining the authentication response, verify the user-supplied secret matches the shared secret; and
upon verifying that the user-supplied secret matches the shared secret, provide the client computer access to a protected resource; and
generating an interactive authentication interface configured to allow a user of the mobile device to provide the user-supplied secret, wherein the user is associated with the user identity;
obtaining, through the interactive authentication interface, the user-supplied secret from the user; and
upon obtaining the user-supplied secret, sending the authentication response to the authentication appliance.

17. The non-transitory computer storage medium of claim 16, wherein the interactive authentication interface comprises a pattern lock and the user-supplied secret comprises a pattern lock pattern.

18. The non-transitory computer storage medium of claim 16, wherein the interactive authentication interface comprises a plurality of images and the user-supplied secret comprises an image selected from the plurality of images.

19. The non-transitory computer storage medium of claim 16, wherein the authentication response comprises the user-supplied secret.

20. The non-transitory computer storage medium of claim 16, wherein the mobile client application comprising executable code directs the mobile device to, prior to sending the authentication response to the authentication appliance, verify that the user-supplied secret matches the shared secret, and wherein the authentication response comprises an indication that the user-supplied secret matches the shared secret.
